(19) United States
(12) Patent Application Publication
(10) Pub. No.: US 2025/0150507 A1
(43) Pub. Date: May 8, 2025

(54) SIGNAL AND PROCEDURE DESIGNS OF BACKSCATTERING DEVICES FOR A-IOT

(71) Applicant: MEDIATEK INC., Hsinchu (TW)

(72) Inventors: Chien-Chun CHENG, Hsinchu (TW); Chiao-Yao Chuang, Hsinchu (TW); Wei-DE Wu, Hsinchu (TW); CHIOU-WEI TSAI, Hsinchu (TW); Tai-Cheng Tsai, Hsinchu (TW)

(21) Appl. No.: 18/929,876

(22) Filed: Oct. 29, 2024

Related U.S. Application Data
(60) Provisional application No. 63/595,786, filed on Nov. 3, 2023.

(51) Int. Cl. H04L 67/12; H04L 5/00; H04W 72/0446

(52) U.S. Cl. CPC H04L 67/12; H04L 5/0055; H04W 72/0446

(57) ABSTRACT

In an aspect of the disclosure, a method, a computer-readable medium, and an apparatus are provided. The apparatus may be a reader. The reader broadcasts a radio signal indicating an available slot set. The reader transmits an acknowledge (ACK) signal including a decoded sequence to an ambient internet of things (A-IoT) device. The reader receives an identifier from the A-IoT device. The identifier is a reply of the A-IoT device when there is a match between the decoded sequence and a chosen sequence, and the chosen sequence is a random sequence that responds to the radio signal in a random slot chosen from the available slot set.

### CROSS-REFERENCE TO RELATED APPLICATION(S)

This application claims the benefits of U.S. Provisional Application Ser. No. 63/595,786, entitled “SIGNAL AND PROCEDURE DESIGNS OF BACKSCATTERING DEVICES FOR A-IoT” and filed on Nov. 3, 2023, which is expressly incorporated by reference herein in its entirety.

### BACKGROUND

### Field

The present disclosure relates generally to wireless communications, and more particularly, to the signaling and operating procedures of backscattering devices in Ambient Internet of Things (A-IoT) systems.

### Background

The statements in this section merely provide background information related to the present disclosure and may not constitute prior art.

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a reader. The reader broadcasts a radio signal indicating an available slot set. The reader transmits an acknowledge (ACK) signal including a decoded sequence to an ambient internet of things (A-IoT) device. The reader receives an identifier from the A-IoT device. The identifier is a reply of the A-IoT device when there is a match between the decoded sequence and a chosen sequence, and the chosen sequence is a random sequence that responds to the radio signal in a random slot chosen from the available slot set.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2 is a diagram illustrating a base station in communication with a UE in an access network.

FIG. 3 illustrates an example logical architecture of a distributed access network.

FIG. 4 illustrates an example physical architecture of a distributed access network.

FIG. 5 is a diagram showing an example of a DL-centric slot.

FIG. 6 is a diagram showing an example of an UL-centric slot.

FIG. 7 is a diagram illustrating an example wireless communication system including a base station and a UE.

FIG. 8 is a diagram illustrating an example wireless link between a gNB and an A-IoT device.

FIG. 9(A) is a diagram illustrating an example communication link between a gNB and an A-IoT device though a connection with a UE via a wired cable.

FIG. 9(B) is a diagram illustrating an example communication link between a gNB and an A-IoT device though a connection with a UE via a wireless air interface.

FIG. 10(A) is a diagram illustrating a first type of an A-IoT device.

FIG. 10(B) is a diagram illustrating a second type of an A-IoT device.

FIG. 10(C) is a diagram illustrating a third type of an A-IoT device.

FIG. 11(A) is a diagram illustrating an example communication link between a UE and an A-IoT device via an air interface.

FIG. 11(B) is a diagram illustrating an example time sequence for a communication process between a UE and an A-IoT device via an air interface.

FIG. 11(C) is a diagram illustrating an example communication process between a UE and an A-IoT device based on a chosen slot.

FIG. 11(D) is a diagram illustrating an example communication process between a UE and an A-IoT device based on a chosen time duration.

FIG. 12(A) is a diagram illustrating an example communication sequence between a UE and an A-IoT device.

FIG. 12(B) is a diagram illustrating an example communication process between a gNB, a UE and an A-IoT device.

FIG. 13 is a sequence diagram that outlines the interactions between a UE and a gNB regarding an uplink power control.

FIG. 14(A) is a sequence diagram that outlines the interactions between a UE and a gNB in the context of 5G NR uplink beam management for a reader to an A-IoT device (R2D) link.

FIG. 14(B) is a sequence diagram that outlines the interactions between a UE and a gNB in the context of the R2D communication with a special type of measurement gap.

FIG. 14(C) is a sequence diagram that outlines the interactions between a UE and a gNB in the context of DL beam measurement for the R2D communication.

FIG. 15 is a sequence diagram that outlines the interactions between a UE and a gNB in the context of querying an A-IoT device's Electronic Product Code (EPC).

FIG. 16(A) is a sequence diagram illustrates the interaction between a gNB, a UE, and an A-IoT device during a configuration process in which the gNB controls the R2D link.

FIG. 16(B) is a sequence diagram illustrates the interaction between a gNB, a UE, and an A-IoT device during a configuration process in which the gNB controls the D2R link.

FIG. 17 illustrates an example communication system having an example communication apparatus and an example network apparatus.

FIG. 18(A) is a flow chart of a process for identifying regarding a reader and an A-IoT device.

FIG. 18(B) is a flow chart of another process for identifying regarding a reader and an A-IoT device.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunications systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example aspects, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

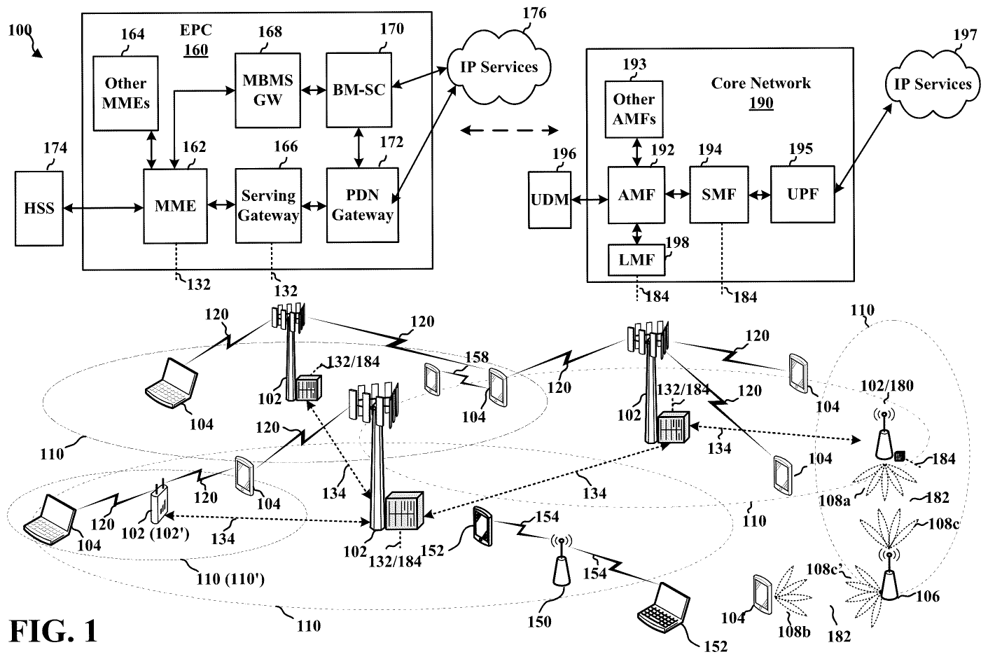

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through backhaul links 132 (e.g., SI interface). The base stations 102 configured for 5G NR (collectively referred to as Next Generation RAN (NG-RAN)) may interface with core network 190 through backhaul links 184. In addition to other functions, the base stations 102 may perform one or more of the following functions: transfer of user data, radio channel ciphering and deciphering, integrity protection, header compression, mobility control functions (e.g., handover, dual connectivity), inter cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over backhaul links 134 (e.g., X2 interface). The backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to 7 MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include an eNB, gNodeB (gNB), or another type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band (e.g., 3 GHz-300 GHz) has extremely high path loss and a short range. The mmW base station 180 may utilize beamforming 182 with the UE 104 to compensate for the extremely high path loss and short range.

The base station 180 may transmit a beamformed signal to the UE 104 in one or more transmit directions 108a. The UE 104 may receive the beamformed signal from the base station 180 in one or more receive directions 108b. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include a Access and Mobility Management Function (AMF) 192, other AMFs 193, a location management function (LMF) 198, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the SMF 194 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, and/or other IP services.

The base station may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Although the present disclosure may reference 5G New Radio (NR), the present disclosure may be applicable to other similar areas, such as LTE, LTE-Advanced (LTE-A), Code Division Multiple Access (CDMA), Global System for Mobile communications (GSM), or other wireless/radio access technologies.

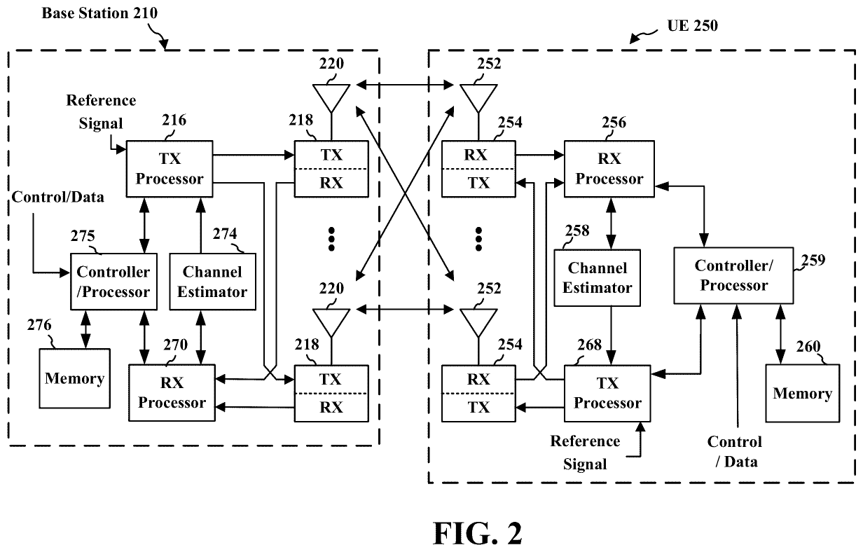

FIG. 2 is a block diagram of a base station 210 in communication with a UE 250 in an access network. In the DL, IP packets from the EPC 160 may be provided to a controller/processor 275. The controller/processor 275 implements layer 3 and layer 2 functionality. Layer 3 includes a radio resource control (RRC) layer, and layer 2 includes a packet data convergence protocol (PDCP) layer, a radio link control (RLC) layer, and a medium access control (MAC) layer. The controller/processor 275 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 216 and the receive (RX) processor 270 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 216 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 274 may be used to determine the coding and modulation scheme, as well as for spatial processing. The channel estimate may be derived from a reference signal and/or channel condition feedback transmitted by the UE 250. Each spatial stream may then be provided to a different antenna 220 via a separate transmitter 218TX. Each transmitter 218TX may modulate an RF carrier with a respective spatial stream for transmission.

At the UE 250, each receiver 254RX receives a signal through its respective antenna 252. Each receiver 254RX recovers information modulated onto an RF carrier and provides the information to the receive (RX) processor 256. The TX processor 268 and the RX processor 256 implement layer 1 functionality associated with various signal processing functions. The RX processor 256 may perform spatial processing on the information to recover any spatial streams destined for the UE 250. If multiple spatial streams are destined for the UE 250, they may be combined by the RX processor 256 into a single OFDM symbol stream. The RX processor 256 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 210. These soft decisions may be based on channel estimates computed by the channel estimator 258. The soft decisions are then decoded and deinterleaved to recover the data and control signals that were originally transmitted by the base station 210 on the physical channel. The data and control signals are then provided to the controller/processor 259, which implements layer 3 and layer 2 functionality.

The controller/processor 259 can be associated with a memory 260 that stores program codes and data. The memory 260 may be referred to as a computer-readable medium. In the UL, the controller/processor 259 provides demultiplexing between transport and logical channels, packet reassembly, deciphering, header decompression, and control signal processing to recover IP packets from the EPC 160. The controller/processor 259 is also responsible for error detection using an ACK and/or NACK protocol to support HARQ operations.

Similar to the functionality described in connection with the DL transmission by the base station 210, the controller/processor 259 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 258 from a reference signal or feedback transmitted by the base station 210 may be used by the TX processor 268 to select the appropriate coding and modulation schemes, and to facilitate spatial processing. The spatial streams generated by the TX processor 268 may be provided to different antenna 252 via separate transmitters 254TX. Each transmitter 254TX may modulate an RF carrier with a respective spatial stream for transmission. The UL transmission is processed at the base station 210 in a manner similar to that described in connection with the receiver function at the UE 250. Each receiver 218RX receives a signal through its respective antenna 220. Each receiver 218RX recovers information modulated onto an RF carrier and provides the information to a RX processor 270.

The controller/processor 275 can be associated with a memory 276 that stores program codes and data. The memory 276 may be referred to as a computer-readable medium. In the UL, the controller/processor 275 provides demultiplexing between transport and logical channels, packet reassembly, deciphering, header decompression, control signal processing to recover IP packets from the UE 250. IP packets from the controller/processor 275 may be provided to the EPC 160. The controller/processor 275 is also responsible for error detection using an ACK and/or NACK protocol to support HARQ operations.

New radio (NR) may refer to radios configured to operate according to a new air interface (e.g., other than Orthogonal Frequency Divisional Multiple Access (OFDMA)-based air interfaces) or fixed transport layer (e.g., other than Internet Protocol (IP)). NR may utilize OFDM with a cyclic prefix (CP) on the uplink and downlink and may include support for half-duplex operation using time division duplexing (TDD). NR may include Enhanced Mobile Broadband (eMBB) service targeting wide bandwidth (e.g. 80 MHz beyond), millimeter wave (mmW) targeting high carrier frequency (e.g. 60 GHz), massive MTC (mMTC) targeting non-backward compatible MTC techniques, and/or mission critical targeting ultra-reliable low latency communications (URLLC) service.

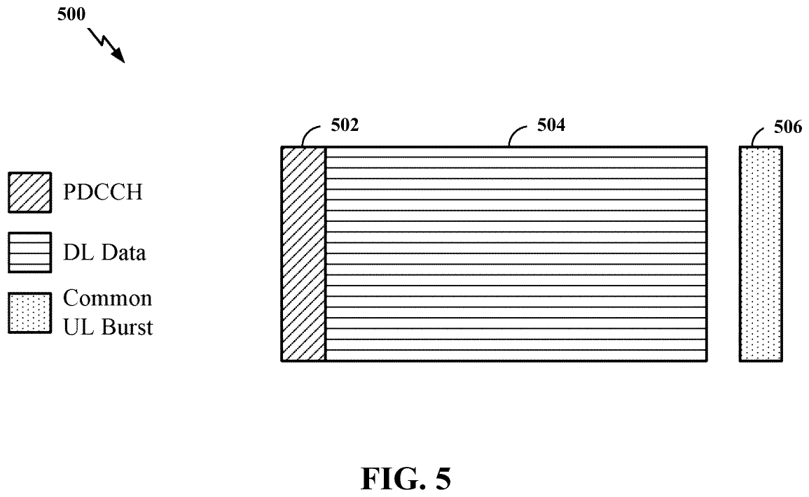

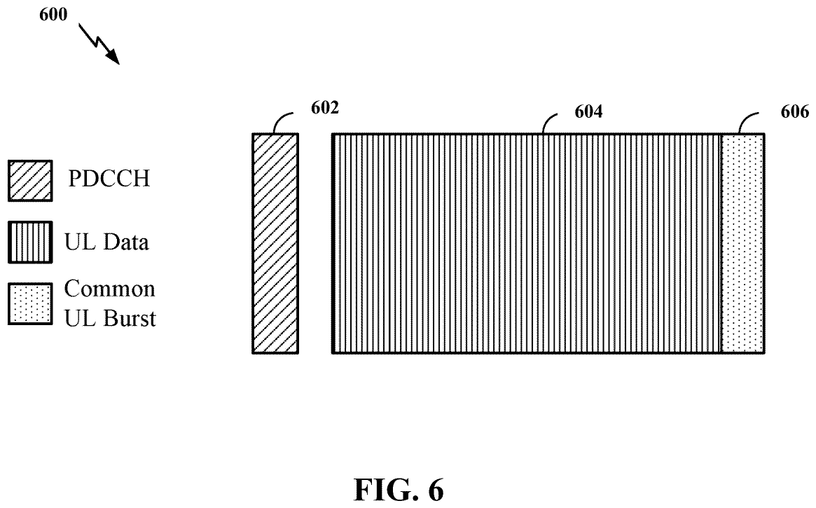

A single component carrier bandwidth of 100 MHz may be supported. In one example, NR resource blocks (RBs) may span 12 sub-carriers with a sub-carrier bandwidth of 60 kHz over a 0.25 ms duration or a bandwidth of 30 kHz over a 0.5 ms duration (similarly, 50 MHz BW for 15 kHz SCS over a 1 ms duration). Each radio frame may consist of 10 subframes (10, 20, 40 or 80 NR slots) with a length of 10 ms. Each slot may indicate a link direction (i.e., DL or UL) for data transmission and the link direction for each slot may be dynamically switched. Each slot may include DL/UL data as well as DL/UL control data. UL and DL slots for NR may be as described in more detail below with respect to FIGS. 5 and 6.

The NR RAN may include a central unit (CU) and distributed units (DUs). A NR BS (e.g., gNB, 5G Node B, Node B, transmission reception point (TRP), access point (AP)) may correspond to one or multiple BSs. NR cells can be configured as access cells (ACells) or data only cells (DCells). For example, the RAN (e.g., a central unit or distributed unit) can configure the cells. DCells may be cells used for carrier aggregation or dual connectivity and may not be used for initial access, cell selection/reselection, or handover. In some cases DCells may not transmit synchronization signals (SS) in some cases DCells may transmit SS. NR BSs may transmit downlink signals to UEs indicating the cell type. Based on the cell type indication, the UE may communicate with the NR BS. For example, the UE may determine NR BSs to consider for cell selection, access, handover, and/or measurement based on the indicated cell type.

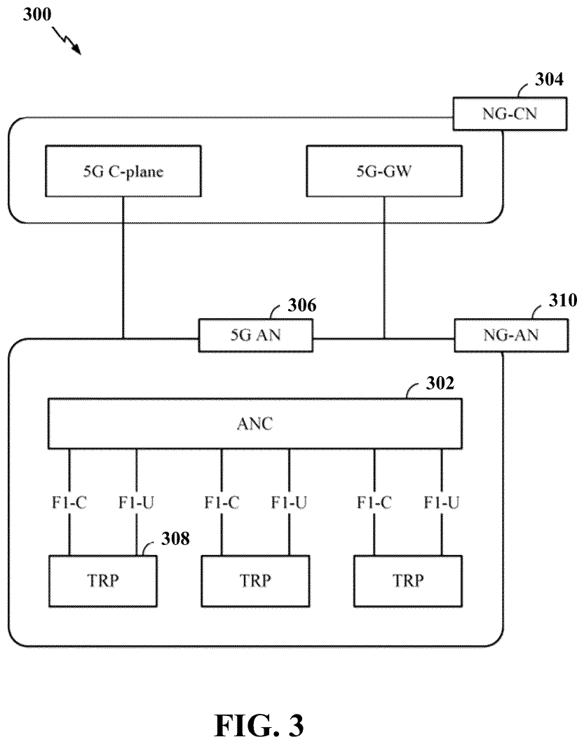

FIG. 3 illustrates an example logical architecture of a distributed RAN 300, according to aspects of the present disclosure. A 5G access node 306 may include an access node controller (ANC) 302. The ANC may be a central unit (CU) of the distributed RAN. The backhaul interface to the next generation core network (NG-CN) 304 may terminate at the ANC. The backhaul interface to neighboring next generation access nodes (NG-ANs) 310 may terminate at the ANC. The ANC may include one or more TRPs 308 (which may also be referred to as BSs, NR BSs, Node Bs, 5G NBs, APs, or some other term). As described above, a TRP may be used interchangeably with “cell.”

The TRPs 308 may be a distributed unit (DU). The TRPs may be connected to one ANC (ANC 302) or more than one ANC (not illustrated). For example, for RAN sharing, radio as a service (RaaS), and service specific ANC deployments, the TRP may be connected to more than one ANC. A TRP may include one or more antenna ports. The TRPs may be configured to individually (e.g., dynamic selection) or jointly (e.g., joint transmission) serve traffic to a UE.

The local architecture of the distributed RAN 300 may be used to illustrate fronthaul definition. The architecture may be defined that support fronthauling solutions across different deployment types. For example, the architecture may be based on transmit network capabilities (e.g., bandwidth, latency, and/or jitter). The architecture may share features and/or components with LTE. According to aspects, the next generation AN (NG-AN) 310 may support dual connectivity with NR. The NG-AN may share a common fronthaul for LTE and NR.

The architecture may enable cooperation between and among TRPs 308. For example, cooperation may be preset within a TRP and/or across TRPs via the ANC 302. According to aspects, no inter-TRP interface may be needed/present.

According to aspects, a dynamic configuration of split logical functions may be present within the architecture of the distributed RAN 300. The PDCP, RLC, MAC protocol may be adaptably placed at the ANC or TRP.

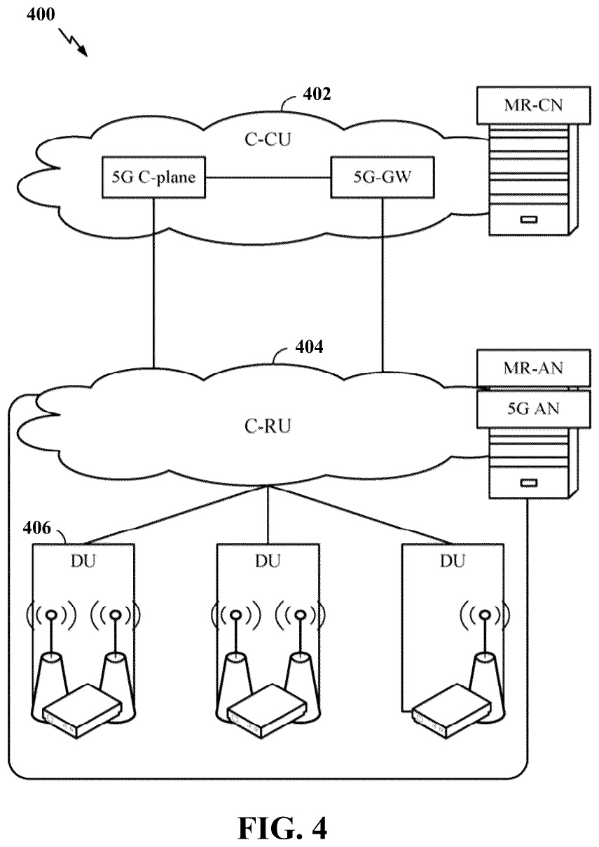

FIG. 4 illustrates an example physical architecture of a distributed RAN 400, according to aspects of the present disclosure. A centralized core network unit (C-CU) 402 may host core network functions. The C-CU may be centrally deployed. C-CU functionality may be offloaded (e.g., to advanced wireless services (AWS)), in an effort to handle peak capacity. A centralized RAN unit (C-RU) 404 may host one or more ANC functions. Optionally, the C-RU may host core network functions locally. The C-RU may have distributed deployment. The C-RU may be closer to the network edge. A distributed unit (DU) 406 may host one or more TRPs. The DU may be located at edges of the network with radio frequency (RF) functionality.

FIG. 5 is a diagram 500 showing an example of a DL-centric slot. The DL-centric slot may include a control portion 502. The control portion 502 may exist in the initial or beginning portion of the DL-centric slot. The control portion 502 may include various scheduling information and/or control information corresponding to various portions of the DL-centric slot. In some configurations, the control portion 502 may be a physical DL control channel (PDCCH), as indicated in FIG. 5. The DL-centric slot may also include a DL data portion 504. The DL data portion 504 may sometimes be referred to as the payload of the DL-centric slot. The DL data portion 504 may include the communication resources utilized to communicate DL data from the scheduling entity (e.g., UE or BS) to the subordinate entity (e.g., UE). In some configurations, the DL data portion 504 may be a physical DL shared channel (PDSCH).

The DL-centric slot may also include a common UL portion 506. The common UL portion 506 may sometimes be referred to as an UL burst, a common UL burst, and/or various other suitable terms. The common UL portion 506 may include feedback information corresponding to various other portions of the DL-centric slot. For example, the common UL portion 506 may include feedback information corresponding to the control portion 502. Non-limiting examples of feedback information may include an ACK signal, a NACK signal, a HARQ indicator, and/or various other suitable types of information. The common UL portion 506 may include additional or alternative information, such as information pertaining to random access channel (RACH) procedures, scheduling requests (SRs), and various other suitable types of information.

As illustrated in FIG. 5, the end of the DL data portion 504 may be separated in time from the beginning of the common UL portion 506. This time separation may sometimes be referred to as a gap, a guard period, a guard interval, and/or various other suitable terms. This separation provides time for the switch-over from DL communication (e.g., reception operation by the subordinate entity (e.g., UE)) to UL communication (e.g., transmission by the subordinate entity (e.g., UE)). One of ordinary skill in the art will understand that the foregoing is merely one example of a DL-centric slot and alternative structures having similar features may exist without necessarily deviating from the aspects described herein.

FIG. 6 is a diagram 600 showing an example of an UL-centric slot. The UL-centric slot may include a control portion 602. The control portion 602 may exist in the initial or beginning portion of the UL-centric slot. The control portion 602 in FIG. 6 may be similar to the control portion 502 described above with reference to FIG. 5. The UL-centric slot may also include an UL data portion 604. The UL data portion 604 may sometimes be referred to as the pay load of the UL-centric slot. The UL portion may refer to the communication resources utilized to communicate UL data from the subordinate entity (e.g., UE) to the scheduling entity (e.g., UE or BS). In some configurations, the control portion 602 may be a physical DL control channel (PDCCH).

As illustrated in FIG. 6, the end of the control portion 602 may be separated in time from the beginning of the UL data portion 604. This time separation may sometimes be referred to as a gap, guard period, guard interval, and/or various other suitable terms. This separation provides time for the switch-over from DL communication (e.g., reception operation by the scheduling entity) to UL communication (e.g., transmission by the scheduling entity). The UL-centric slot may also include a common UL portion 606. The common UL portion 606 in FIG. 6 may be similar to the common UL portion 506 described above with reference to FIG. 5. The common UL portion 606 may additionally or alternatively include information pertaining to channel quality indicator (CQI), sounding reference signals (SRSs), and various other suitable types of information. One of ordinary skill in the art will understand that the foregoing is merely one example of an UL-centric slot and alternative structures having similar features may exist without necessarily deviating from the aspects described herein.

In some circumstances, two or more subordinate entities (e.g., UEs) may communicate with each other using sidelink signals. Real-world applications of such sidelink communications may include public safety, proximity services, UE-to-network relaying, vehicle-to-vehicle (V2V) communications, Internet of Everything (IoE) communications, IoT communications, mission-critical mesh, and/or various other suitable applications. Generally, a sidelink signal may refer to a signal communicated from one subordinate entity (e.g., UE1) to another subordinate entity (e.g., UE2) without relaying that communication through the scheduling entity (e.g., UE or BS), even though the scheduling entity may be utilized for scheduling and/or control purposes. In some examples, the sidelink signals may be communicated using a licensed spectrum (unlike wireless local area networks, which typically use an unlicensed spectrum).

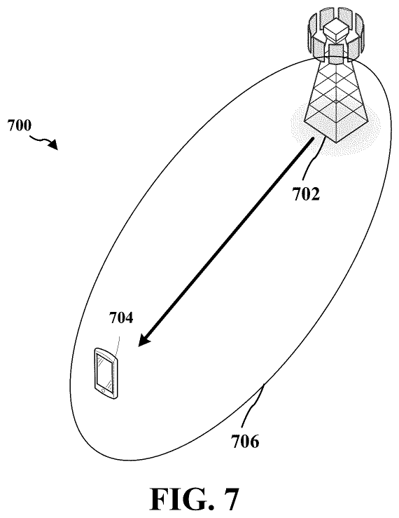

FIG. 7 is a diagram 700 illustrating an example wireless communication system including a base station and a UE. In this example, a UE 704 is connected to a base station 702 on a cell 706.

The field of Ambient Internet of Things (A-IoT) currently faces a challenge due to the absence of standardization in the signaling and operating procedures of backscattering devices. This lack of standardization can potentially lead to inconsistencies and inefficiencies in the system operation.

In an A-IoT system, an Ambient IoT device is designed to communicate directly and bidirectionally with a base station (BS). This communication encompasses the transmission and reception of Ambient IoT data and/or signaling. Intriguingly, the base station transmitting to the Ambient IoT device may not be the same as the one receiving from it, adding a layer of complexity to the system topology.

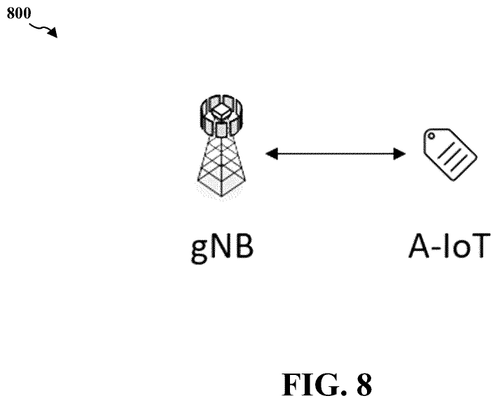

FIG. 8 is a diagram 800 illustrating an example wireless link between a next-generation NodeB (gNB) and an A-IoT device. An area of ambiguity in the current A-IoT setup is the nature of the wireless link between the gNB and the A-IoT device. Specifically, it is unclear if this link employs the New Radio User Plane (NR Uu) interface, which is typically used to connect a User Equipment (UE) to the gNB over the air. This lack of clarity can lead to confusion and potential inefficiencies in the design and operation of A-IoT systems.

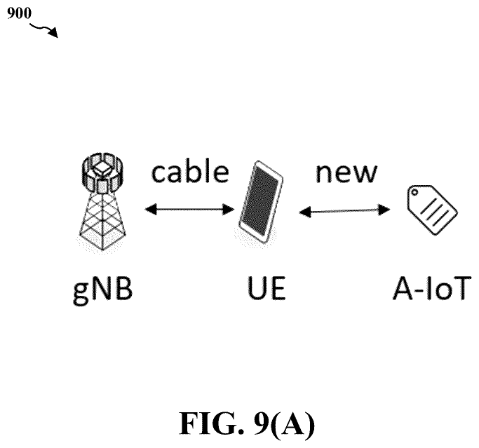

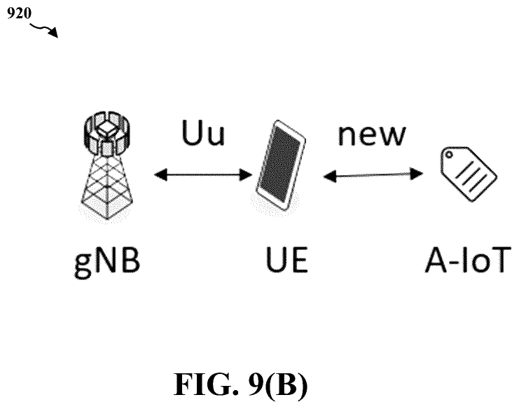

FIG. 9(A) is a diagram 900 illustrating an example communication link between the gNB and the A-IoT device though a connection with the UE via a wired cable.

The present disclosure introduces a novel system topology for Ambient Internet of Things (A-IoT) communication. As shown in FIG. 9(A), the gNB establishes a connection with a UE or a UE reader via a wired cable. This configuration eliminates the need for a new air interface between the gNB and the A-IoT device, instead introducing a new air interface between the UE reader and the A-IoT device. As a result, the efforts required for any gNB specification change are significantly reduced. In this setup, the gNB can access the A-IoT device via the UE reader, which acts as an intermediate node between the device and the base station (gNB).

FIG. 9(B) is a diagram 920 illustrating an example communication link between the gNB and the A-IoT device though a connection with the UE via a wireless air interface. As shown in FIG. 9(B), a wireless air interface is established between the gNB and a UE or a UE reader. This air interface leverages the NR-Uu interface to minimize the specification change on the UE side. A new air interface between the UE and the A-IoT device is necessitated, the specifications of which can be determined based on the use cases and their corresponding requirements.

The disclosure is particularly relevant in the context of smart factories, a market projected to reach $1430 Billion by 2030. One of the primary demands from this industry is for inventory use cases. The requirements for such use cases include ultra-low power transceiver and device architectures, low-complexity waveform, modulation, coding, signal, channel, and synchronization schemes, indoor coverage, and low mobility.

To meet these requirements, the disclosure proposes the use of transmission based on backscattering, including the provision of a carrier wave for backscattering. The A-IoT devices are categorized into three types in accordance with this approach.

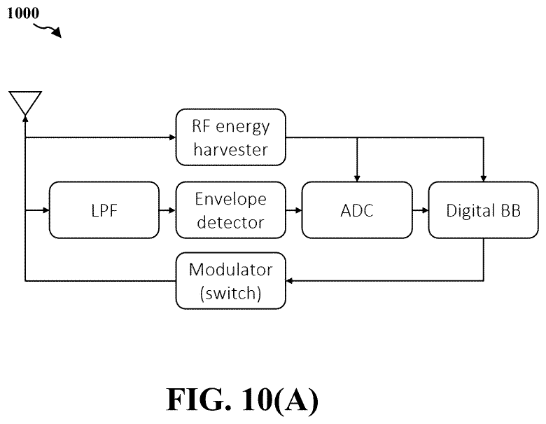

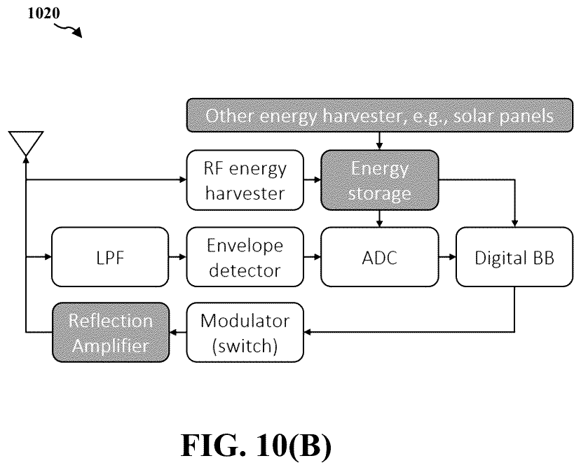

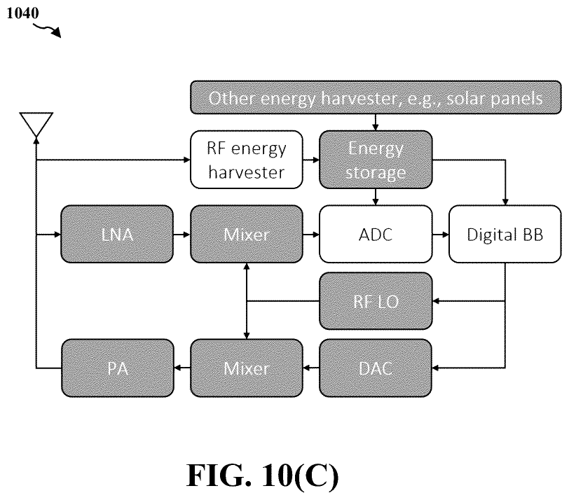

FIG. 10(A) is a diagram 1000 illustrating a first type of the A-IoT devices, i.e., Device A. Device A is designed with specific targets for power consumption during transmission/reception (≤1 μW or ≤10 μW), and complexity, which is aimed to be comparable to UHF RFID ISO18000-6C (EPC C1G2). Device A does not have energy storage or independent signal generation/amplification capabilities, and relies on backscattering transmission. It requires a backscattering activation power threshold, experiences reflection loss, and needs a distant carrier wave source to transmit signals for positioning.

The architecture of Device A includes the following components:
1) A low pass filter (LPF) for suppressing adjacent sub-carrier interference (ASCI) and adjacent carrier interference (ACI)
2) An envelope detector (ED) to support On-Off Keying (OOK)-based signals
3) An analog to digital converter (ADC) for digital baseband processing
4) A digital baseband (DBB) for sequence matching
5) A modulator (switch) controlled by the incoming signal to add payload data for OOK modulation
6) A radio frequency energy harvester to convert RF signals into an energy source

FIG. 10(B) is a diagram 1020 illustrating a second type of the A-IoT devices, i.e., Device B. Device B's design targets lie between those of Device A and Device C in terms of power and complexity. It has energy storage but no independent signal generation, relying on backscattering transmission. Stored energy can be used for signal amplification. Device B also requires a backscattering activation power threshold, experiences reflection loss, and needs a distant carrier wave source for positioning.

The architecture of Device B includes the following components:
1) An LPF for suppressing ASCI and ACI
2) An ED to support OOK-based signals
3) An ADC for digital baseband processing
4) A DBB for sequence matching
5) A modulator controlled by the incoming signal to add payload data for OOK modulation
6) An RF energy harvester to convert RF signals into an energy source
7) Additional energy harvesters for different types of ambient power sources, such as RF radio, solar energy, thermal energy, and piezoelectric power
8) Energy storage, such as capacitors and solid-state batteries
9) A reflection amplifier to amplify the input signal to the tag and the backscattered signal towards the reader

FIG. 10(C) is a diagram 1040 illustrating a third type of the A-IoT devices, i.e. Device C. Device C is designed with a power consumption target during transmission/reception of ≤1 mW to ≤10 mW, and a complexity target that is orders-of-magnitude lower than NarrowBand IoT (NB-IoT). Device C has energy storage, independent signal generation, and active RF components for transmission. It also has mobility management capabilities, at least for cell selection/re-selection.

The architecture of Device C includes the following components:
1) An LPF for suppressing ASCI and ACI
2) An ED to support OOK-based signals
3) An ADC for digital baseband processing
4) A DBB for synchronization, payload decoding, and cyclic redundancy check (CRC)
5) An RF energy harvester to convert RF signals into an energy source
6) Additional energy harvesters for different types of ambient power sources, such as RF radio, solar energy, thermal energy, and piezoelectric power
7) Energy storage, such as capacitors and solid-state batteries
8) A low-noise amplifier (LNA) and power amplifier (PA) to amplify reception and transmission signals

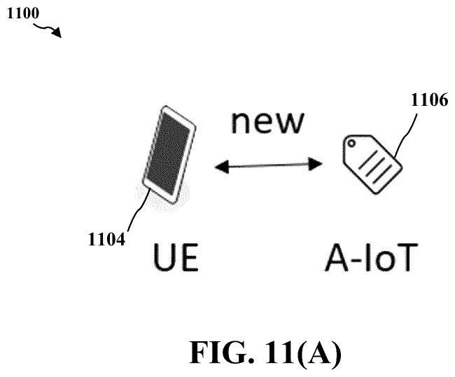

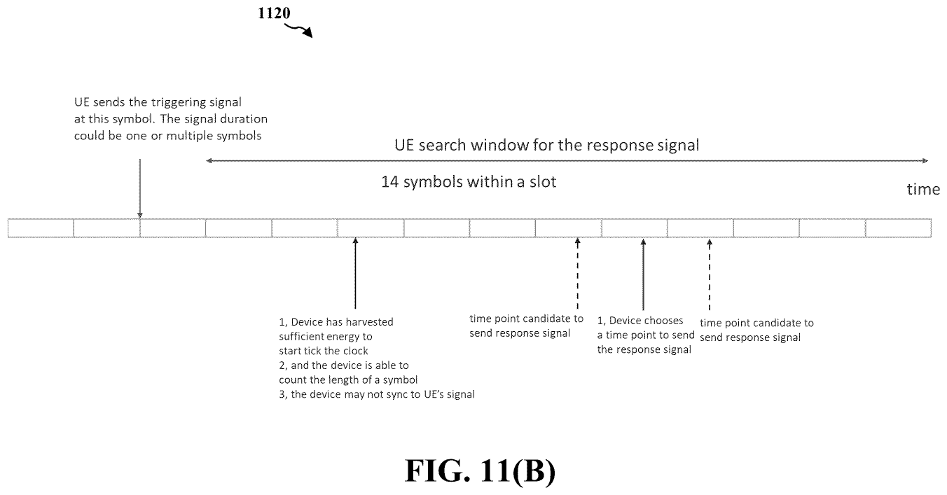

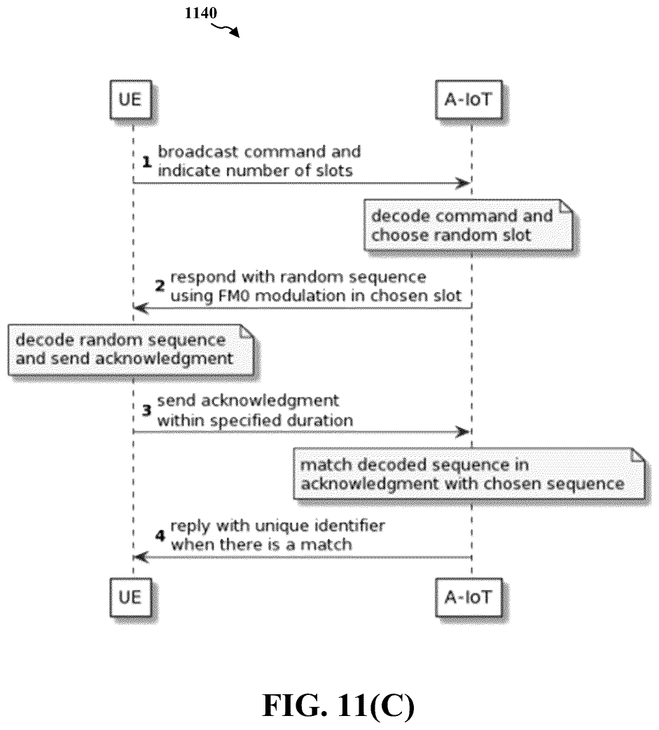

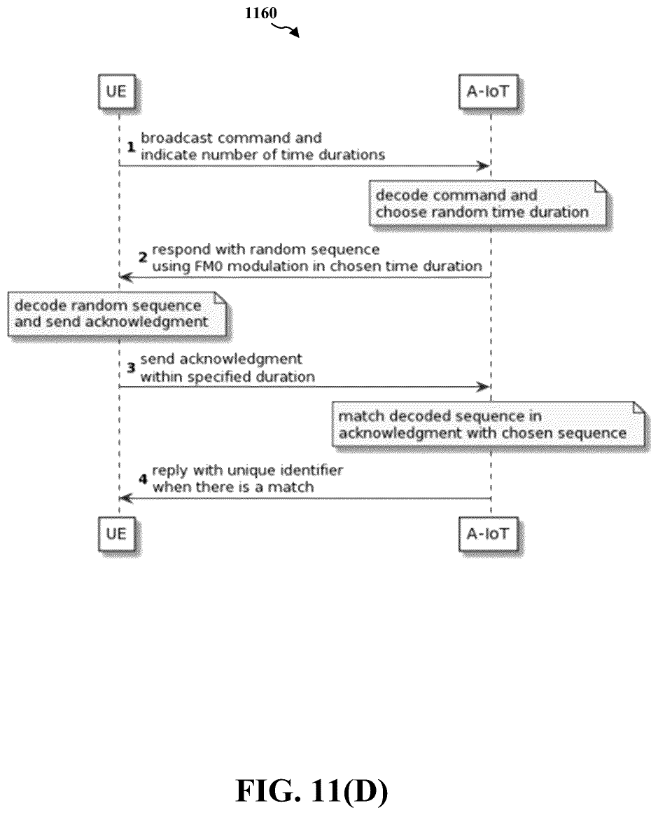

FIG. 11(A) is a diagram 1100 illustrating an example communication link between a UE such as the UE 1104 and an A-IoT device such as the A-IoT device 1106 via an air interface.

The disclosure introduces a new air interface for communication between the UE 1104 and the A-IoT device 1106. The communication process begins with the UE 1104 energizing the A-IoT device 1106 and transmitting a command. This command specifies essential communication parameters such as the tag rate, the tag data encoding method, and the total number of available slots.

Upon harvesting sufficient energy, the A-IoT device 1106 activates and listens for the UE's command. After decoding the command, the A-IoT device 1106 randomly selects a slot from the available range and generates a random sequence. This sequence is then transmitted in the chosen slot, preceded by a known preamble sequence.

FIG. 11(B) is a diagram 1120 illustrating an example time sequence for a communication process between the UE 1104 and the A-IoT device 1106 via an air interface.

In response to the A-IoT's transmission, the UE 1104 decodes the received preamble sequence and sends an acknowledgment back to the A-IoT 1106 within a predetermined duration, conforming to the system's configuration for the A-IoT rate.

FIG. 11(C) is a diagram 1140 illustrating an example communication process between the UE 1104 and the A-IoT device 1106 based on a chosen slot.

Within the UE 1104, a new function dubbed the “A-IoT Decoder” is responsible for frame synchronization, channel estimation, and detection of the A-IoT responses. Synchronization of the A-IoT's sequences is accomplished by correlating the received signal with the known preamble. Following synchronization, channel estimation is performed using the preamble.

In some embodiments, the disclosure presents an innovative air interface for communication between the UE 1104 and the A-IoT device 1106. The communication process is initiated when the UE 1104 powers up the A-IoT device 1106 and transmits a command. This command outlines essential communication parameters such as the tag rate, the tag data encoding method, and the total number of available time durations.

Once the A-IoT device 1106 has harvested enough energy, it gets activated and listens for the UE's command. After decoding the command, the A-IoT device 1106 randomly selects a time duration from the available range, and generates a random sequence. This sequence is then transmitted in the chosen time duration, preceded by a known preamble sequence.

In response to the A-IoT's transmission, the UE 1104 decodes the received preamble sequence and/or the random sequence and sends an acknowledgment back to the A-IoT device 1106 within a predetermined duration, aligning with the system's configuration for the A-IoT rate.

FIG. 11(D) is a diagram 1160 illustrating an example communication process between the UE 1104 and the A-IoT device 1106 based on a chosen time duration. This process is similar to that depicted in FIG. 11(C), with the exception that the slot is replaced by the time duration.

The UE 1104 incorporates a new function known as the “A-IoT Decoder” that is responsible for frame synchronization, channel estimation, and detection of the A-IoT responses. Synchronization of the A-IoT's sequences is achieved by correlating the received signal with the known preamble. Following synchronization, channel estimation is performed using the preamble.

### User Equipment to Ambient IoT Device Communication Link (U2A Link)

The U2A (also referred to as Reader to Device, R2D) link employs modulation schemes such as Amplitude Shift Keying (ASK) or On-Off Keying (OOK), with OOK-1 for single-chip per OFDM symbol transmission and OOK-4 for M-chip per OFDM symbol transmission, the ASK including Double Sideband Amplitude Shift Keying (DSB-ASK), Single Sideband Amplitude Shift Keying (SSB-ASK), and Partial Response Amplitude Shift Keying (PR-ASK):

Double Sideband Amplitude Shift Keying (DSB-ASK): A modulation technique where both the upper and lower sidebands of the carrier signal are used to transmit data. It is less bandwidth-efficient but simpler to implement.

Single Sideband Amplitude Shift Keying (SSB-ASK): A modulation technique where only one of the sidebands (either upper or lower) of the carrier signal is used to transmit data. It is more bandwidth-efficient but requires more sophisticated equipment for implementation.

Partial Response Amplitude Shift Keying (PR-ASK): A modulation scheme designed to increase the data rate without increasing the bandwidth. It involves transitions between different amplitude levels over several symbol periods, requiring more complex signal processing at the receiver.

The R2D link employs one of the aforementioned ASK modulation schemes to facilitate Pulse Interval Encoding (PIE) for data transmission. PIE is a form of OOK modulation where the duration of the gaps between pulses represents the data. It is widely used due to its robustness against noise and interference.

The UE 1104 may also use Manchester encoding for R2D communication. Manchester Encoding, also known as Phase Encode (PE), is a synchronous clock encoding technique. It combines data and clock signals for self-synchronizing transmission, which is commonly used in Ethernet and local area networks (LANs).

In Manchester Encoding, separate data and clock signals are merged into a single, self-synchronizing data stream. This stream is suitable for transmission over serial channels. Each bit in Manchester Encoding has a transition in the middle, serving as both a clock signal and a data signal. Specifically, a transition from low to high represents a “0,” while a transition from high to low represents a “1.” Reverse encoding schemes can also be applied.

The clock synchronization signal is embedded within the data waveform. This allows the receiver to extract the clock signal directly from the data. Since each bit is represented by two voltage levels in Manchester Encoding, the data transmission rate is half of the modulation rate. Consequently, the coding efficiency is 50%.

On the other hand, PIE is a type of encoding that represents data by defining different time widths between pulse falling edges. The specific time widths between these falling edges are used to distinguish between different data values. Specially, PIE represents data through the timing intervals between pulse falling edges, suitable for applications where pulse timing is crucial.

The R2D link incorporates two known preambles: a long R2D preamble and a short R2D preamble. The long R2D preamble is used for the initial transmission between UE 1104 and A-IoT. Once synchronization has been established, the short preamble can be used at the start of all other signaling.

The UE 1104 transmits the long R2D preamble and a control signal or command. The long R2D preamble enables the A-IoT device 1106 to synchronize with the UE 1104, and the command specifies control parameters, such as data rate, data encoding, and the number of slots N for the A-IoT device 1106 to select and transmit a response sequence.

The control signal or command includes parameters such as operating frequency range, operating channels, frequency hop rate, frequency hop sequence, occupied channel bandwidth, minimum receiver bandwidth, UE transmit maximum EIRP, UE transmit spurious emissions, UE transmitter spectrum mask, timing, modulation, data coding, bit rate, UE transmit modulation accuracy, preamble, bit transmission order, wake-up process, polarization, and other communication parameters.

In another embodiment, in addition to Double Sideband Amplitude Shift Keying (DSB-ASK), Single Sideband Amplitude Shift Keying (SSB-ASK), and Partial Response Amplitude Shift Keying (PR-ASK), there are other waveforms that can be utilized for diverse communication requirements:

Quadrature Amplitude Modulation (QAM): A modulation scheme that combines ASK and Phase Shift Keying (PSK) to increase the data rate without increasing the bandwidth.

Gaussian Frequency Shift Keying (GFSK): A modulation scheme that uses a Gaussian filter to shape the binary symbols before performing frequency shift keying, reducing the spectral width.

Binary Frequency Shift Keying (BFSK): A modulation scheme where the digital information modulates the frequency of the carrier signal between two predefined values.

Quadrature Frequency Shift Keying (QFSK): A modulation scheme that extends BFSK by using four distinct frequency values to transmit two bits per symbol.

Minimum Shift Keying (MSK): A type of FSK where the frequency shift is as small as possible to minimize the required bandwidth.

Continuous Phase Frequency Shift Keying (CPFSK): A modulation scheme where the phase of the carrier is continuously varied according to the input data.

Multi-Frequency Shift Keying (MFSK): A modulation scheme where more than two frequencies are used to transmit multiple bits per symbol.

Offset Quadrature Phase Shift Keying (OQPSK): A modulation scheme that extends QPSK by shifting the phase of the carrier for each symbol to reduce the probability of errors.

Gaussian Minimum Shift Keying (GMSK): A modulation scheme that combines the benefits of GFSK and MSK to provide efficient use of bandwidth.

Orthogonal Frequency Division Multiplexing (OFDM): A modulation scheme that divides the available spectrum into several orthogonal subcarriers, each carrying a part of the data.

These waveforms offer a balance between bandwidth efficiency, implementation complexity, and error performance, making them suitable for different RFID applications.

### Ambient IoT Device to User Equipment Communication Link (A2U Link)

The A2U (also referred to as Device to Reader, D2R) link employs either Amplitude Shift Keying (ASK) or Phase Shift Keying (PSK) modulation, with OOK and Binary PSK for baseband modulation, and minimum shift keying (MSK) as a variant of Binary FSK. The A-IoT encodes backscattered data using either FM0 baseband or Miller modulation, as controlled by the UE 1104 or gNB via the D2R link. FM0 and Miller line codes may be provided for D2R transmission.

FM0 encoding inverts the baseband phase at every symbol boundary, with an additional mid-symbol phase inversion for data-0 or information bit 0. FM0 encoding has memory, so the choice of sequences depends on prior transmissions. FM0 signaling always ends with a “dummy” data-1 bit or information bit 1 at the end of a transmission.

FM0 signaling commences with one of two preambles, depending on the configuration in the command or the control signal. In certain cases, A-IoT uses the extended preamble regardless of the configuration, e.g., the extended preamble is for a delayed or in-process reply.

Miller Encoding inverts its phase between two consecutive data-0s and also in the middle of a data-1 symbol. The state diagram maps data sequences to baseband Miller basis functions. The transmitted waveform is the baseband waveform multiplied by a square-wave at a rate M times the symbol rate. Certain state transitions are disallowed to prevent phase inversion at inappropriate symbol boundaries.

The D2R link signaling commences with one of two Miller Subcarrier Preambles. The choice depends on the command or the control signal. However, if a tag is replying to a command that uses a delayed or in-process reply, it uses the extended preamble regardless of the configuration.

The A-IoT employs backscatter modulation, altering its antenna's reflection coefficient to transmit data, with at least single-tone unmodulated sinusoid waveform as a candidate waveform for a carrier wave for D2R backscattering. The A-IoT uses a fixed modulation format, data encoding, and data rate. The A-IoT selects the modulation format, while the UE 1104 sets the data encoding and data rate.

The D2R link transmits Electronic Product Code (EPC) and Protocol-Control Information (PC). The EPC can represent a product code, or any type of A-IoT data. The PC is a control signal that regulates the radio signal and the timing and format of data transmission.

The typical PC includes parameters such as the operating frequency range, default operating frequency, operating channels, frequency accuracy, frequency hop rate, frequency hop sequence, occupied channel bandwidth, maximum effective isotropic radiated power (EIRP), spectrum mask, unwanted emissions, switch time, dwell time, modulation, on-off ratio, subcarrier signal frequency, accuracy, Miller encoding scheme modulation, nominal duty cycle, data representation, bit transmission rate, accuracy, preamble, bit transmission order, polarization, and minimum tag receiver bandwidth. These parameters can be controlled by the UE or gNB.

### Cyclic-Redundancy Check (CRC)

The Cyclic-Redundancy Check (CRC) is a method employed by tags to verify the validity of commands from the UE 1104, and by readers to check the validity of replies from the A-IoT device 1106. This protocol utilizes two types of CRC: CRC-16 and CRC-5.

### Link Timing

The timing for communication between the UE 1104 and the A-IoT device 1106 can be categorized into immediate, delayed, or in-process replies. The A-IoT device 1106 can respond immediately, conforming to T1 timing (e.g., 500 us), provide delayed replies in accordance with T2 timing (e.g., 20 ms), or issue in-process replies that periodically inform the UE 1104 that it is still processing a command.

### Slotted Aloha Protocol

The Slotted Aloha protocol is a four-step process:

1. Query: The UE 1104 broadcasts a query and indicates the number of available slots.

2. RN16: If an A-IoT device 1106 decodes the query, it selects a random slot and subsequently responds with a 16-bit random sequence (RN16) using FM0 modulation in the chosen slot.

3. ACK: In each slot, if the UE 1104 decodes an RN16, it sends an acknowledgment (ACK) containing the same decoded RN16.

4. EPC: Each tag that decodes the ACK compares the included RN16 to the RN16 it previously selected, and responds with its Electronic Product Code (EPC) when there is a match.

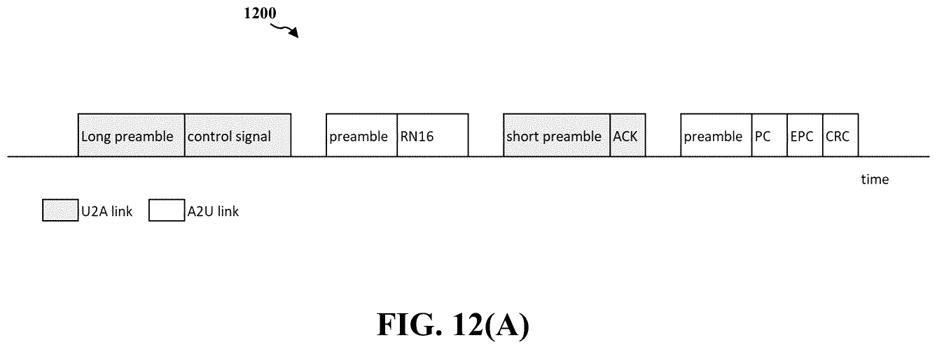

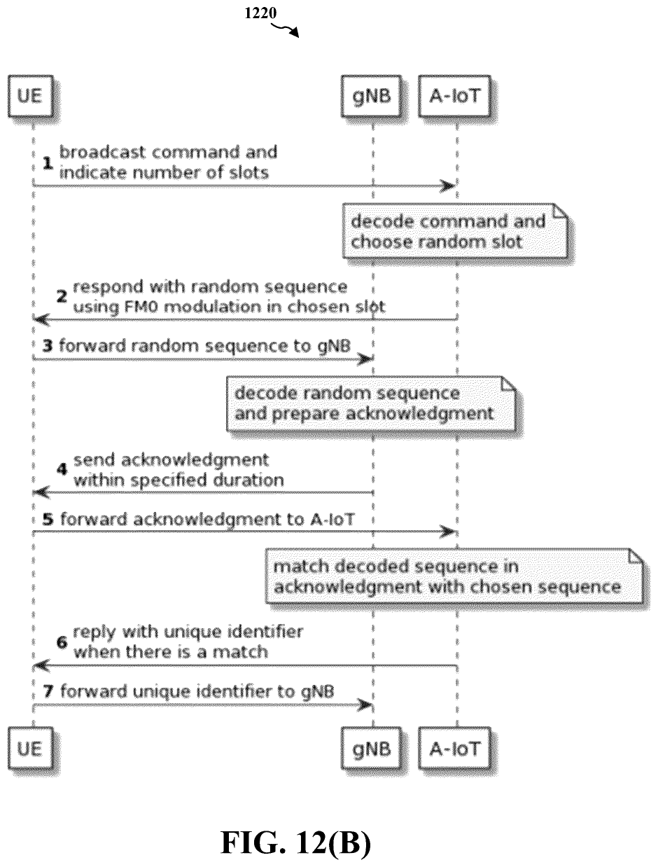

FIG. 12(A) is a diagram 1200 illustrating an example communication sequence between the UE 1104 and the A-IoT device 1106.

The A-IoT device 1106 selects a number between 1 and N, where N is the number of slots provided by the command or the control signal, and transmits a random 16-bit sequence (RN16) in the selected slot, preceded by a known preamble sequence.

The UE 1104 acknowledges the A-IoT device 1106 by sending an ACK signal. If the tag receives the ACK containing the correct RN16, it sends back the reply. After a successful ACK, the UE 1104 can access the acknowledged A-IoT device 1106 for the EPC or Protocol-Control Information (PC).

FIG. 12(B) is a diagram 1220 illustrating an example communication process between a gNB, the UE 1104 and the A-IoT device 1106. As shown in FIG. 12(B):

The UE 1104 broadcasts a command and indicates the number of slots to the A-IoT device 1106.

The A-IoT device 1106 decodes the command, chooses a random slot, and responds with a random sequence using FM0 modulation in the chosen slot.

The UE 1104 forwards the random sequence to the gNB.

The gNB decodes the random sequence and prepares an acknowledgment.

The gNB sends the acknowledgment within a specified duration to the UE 1104.

The UE 1104 forwards the acknowledgment to the A-IoT device 1106.

The A-IoT device 1106 matches the decoded sequence in the acknowledgment with the chosen sequence and replies with a unique identifier when there is a match.

The UE 1104 forwards the unique identifier to the gNB.

In a first aspect, the UE 1104 may include:

One or more non-transitory computer-readable media having computer-executable instructions embodied thereon, and at least one processor coupled to the one or more non-transitory computer-readable media and configured to execute the computer-executable instructions to:

Receive from a base station (BS), a command specifying communication parameters such as the tag rate, the tag data encoding method, and the total number of available slots, if the UE 1104 is in a communication process with the A-IoT device 1106.

Determine a random sequence and a slot from the available range for transmission, if the A-IoT device 1106 has harvested sufficient energy and activated.

Perform frame synchronization, channel estimation, and detection of the A-IoT responses, if the UE 1104 has a new function dubbed the “A-IoT Decoder”.

Transmit, to the BS, an acknowledgment back to the A-IoT device 1106 within a predetermined duration, if the UE 1104 has decoded the received preamble sequence from the A-IoT's transmission.

In a second aspect, the UE 1104 may include:

One or more non-transitory computer-readable media having computer-executable instructions embodied thereon, and at least one processor coupled to the one or more non-transitory computer-readable media and configured to execute the computer-executable instructions to:

Receive from a base station (BS), a command or control signal specifying control parameters such as data rate, data encoding, and the number of slots N for the A-IoT device 1106 to select and transmit a response sequence, if the UE 1104 is in a communication process with the A-IoT device 1106.

Determine the modulation format, while the UE 1104 sets the data encoding and data rate, if the A-IoT device 1106 employs backscatter modulation and alters its antenna's reflection coefficient to transmit data.

Perform the Slotted Aloha protocol, if an A-IoT device 1106 decodes the query, it selects a random slot and subsequently responds with a 16-bit random sequence (RN16) using FM0 modulation in the chosen slot.

Transmit, to the BS, an Electronic Product Code (EPC) when there is a match between the decoded sequence in the acknowledgment with the chosen sequence, if each tag that decodes the ACK compares the included RN16 to the RN16 it previously selected.

### Uplink Power Control

To address the concern of inter-UE interference when the UE 1104 uses UL to connect A-IoT device 1106, the gNB controls the power using these mechanisms. The communication starts with the UE 1104 energizing the A-IoT device 1106 and transmitting a command that outlines essential communication parameters like the tag rate, data encoding method, and the total number of available slots.

To adapt the existing 5G NR power control mechanisms for the UE to A-IoT (R2D) link, several adjustments can be made:

Open Loop and Closed Loop Power Control: These mechanisms could be adapted to consider the specific characteristics of the A-IoT devices, such as their energy harvesting capabilities and their backscatter nature. The path loss calculation in the open loop control could include the energy transfer from the UE 1104 to the A-IoT device 1106, and the TPC commands in the closed loop control could be adjusted based on the quality of the backscattered signal from the A-IoT.

Power Control for PUCCH, PUSCH, and SRS: Since the R2D link uses ASK or OOK modulation, the power control for these channels could be adapted accordingly. For example, the power control offset provided by the base station could be adjusted to optimize the ASK or OOK modulation.

Power Ramping and Power Backoff: These mechanisms could be used to manage the power levels of the R2D link. Power ramping could be used when the UE 1104 initially energizes the A-IoT device 1106, and power backoff could be used when the UE 1104 is transmitting a command to the A-IoT device 1106 to avoid overwhelming the A-IoT device 1106 with too much power.

Timing Adjustments: The timing for the communication could be adapted to the specific requirements of the R2D link. For example, the turn-around time could be adjusted to accommodate the time it takes for the A-IoT device 1106 to harvest energy and respond to the UE's command.

Modulation and Data Encoding: The modulation and data encoding used in the R2D link (e.g., DSB-ASK, SSB-ASK, PR-ASK, and PIE) could be integrated into the power control mechanisms. The power levels could be adjusted to optimize these modulation and data encoding techniques.

Slotted Aloha Protocol: This protocol could be used to manage the communication between the UE 1104 and multiple A-IoTs. The power control mechanisms could be adjusted to accommodate the random slot selection by the A-IoTs and the acknowledgment process by the UE 1104.

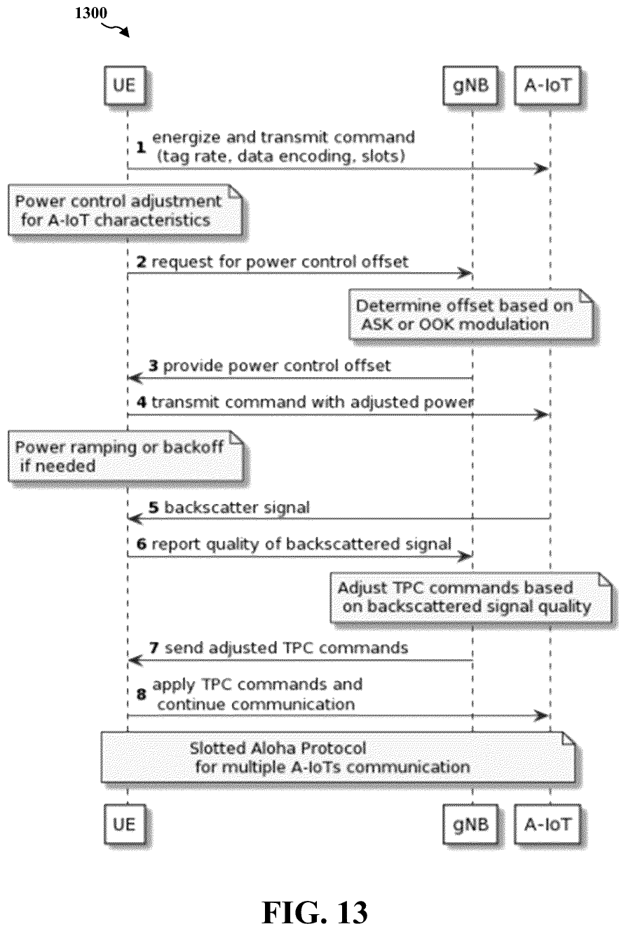

FIG. 13 is a sequence diagram 1300 that outlines the interactions between the UE 1104 and gNB regarding the uplink power control.

This sequence diagram provides a high-level overview of the interactions between the UE 1104, gNB, and A-IoT device 1106 in the context of uplink power control. It covers the primary steps from the UE 1104 energizing the A-IoT device 1106 and transmitting a command, through to the ongoing communication managed by the Slotted Aloha Protocol.

In a first aspect, the UE 1104 may include:

One or more non-transitory computer-readable media having computer-executable instructions embodied thereon, and at least one processor coupled to the one or more non-transitory computer-readable media and configured to execute the computer-executable instructions to:

Receive from a base station (BS), a power control offset for ASK or OOK modulation, if the UE 1104 is in a communication process with the A-IoT device 1106 and the UE 1104 is transmitting a command to the A-IoT device 1106.

Determine a suitable power level for the R2D link by adjusting the received power control offset, if the A-IoT device 1106 has energy harvesting capabilities and a backscatter nature.

Perform power ramping when initially energizing the A-IoT device 1106, and power backoff when transmitting a command to the A-IoT device 1106, if the UE 1104 needs to manage the power levels of the R2D link.

Transmit, to the BS, the quality of the backscattered signal from the A-IoT device 1106, if the UE 1104 has received a backscattered signal from the A-IoT device 1106.

In a second aspect, the UE 1104 may include:

One or more non-transitory computer-readable media having computer-executable instructions embodied thereon, and at least one processor coupled to the one or more non-transitory computer-readable media and configured to execute the computer-executable instructions to:

Receive from a base station (BS), a command specifying communication parameters such as the tag rate, the data encoding method, and the total number of available slots, if the UE 1104 is in a communication process with the A-IoT device 1106.

Determine the timing for the communication based on the specific requirements of the R2D link, if the A-IoT device 1106 needs time to harvest energy and respond to the UE's command.

Perform the Slotted Aloha protocol to manage the communication between the UE 1104 and multiple A-IoTs, if the UE 1104 needs to accommodate the random slot selection by the A-IoTs and the acknowledgment process by the UE 1104.

Transmit, to the BS, the acknowledgment back to the A-IoT device 1106 within a predetermined duration, if the UE 1104 has decoded the received preamble sequence from the A-IoT's transmission.

### UL Beam Management

In the context of a UE to A-IoT (R2D) link, the 5G NR uplink beam management can be adapted to save UE's power and prevent interference with other UEs or A-IoT devices. Here are some possible modifications:

Beam Determination: In the R2D context, the UE 1104 would need to determine the best beam for transmitting to the A-IoT device 1106. This could be done by the UE 1104 sending a set of beam reference signals (BRSs) to the A-IoT device 1106, which would then acknowledge the best beam for communication. This process would need to be energy-efficient to conserve the UE's power.

Beam Measurement: The UE 1104 would measure the quality of the acknowledgment from the A-IoT device 1106 to determine the optimal beam. The measurement criteria could be adapted to consider the specific characteristics of the A-IoT device 1106, such as its energy harvesting capability and its backscatter nature.

Beam Reporting: The UE 1104 would report the optimal beam to the gNB. To prevent interference with other UEs or A-IoT devices, the report could include information about the direction and width of the beam, so that the gNB can coordinate the beam usage among multiple UEs.

Beam Switching: The gNB would command the UE 1104 to switch to the reported beam for uplink transmission to the A-IoT device 1106. The switch would need to be done in a way that minimizes the UE's power consumption and avoids causing interference to other UEs or A-IoT devices.

Beam Tracking: The UE 1104 and the gNB would constantly track the channel conditions and switch to a different beam when necessary. This process would need to be energy-efficient and considerate of the potential interference to other UEs or A-IoT devices.

These adjustments would allow the 5G NR uplink beam management to be effectively used for R2D links, ensuring efficient use of the UE's power and minimizing interference.

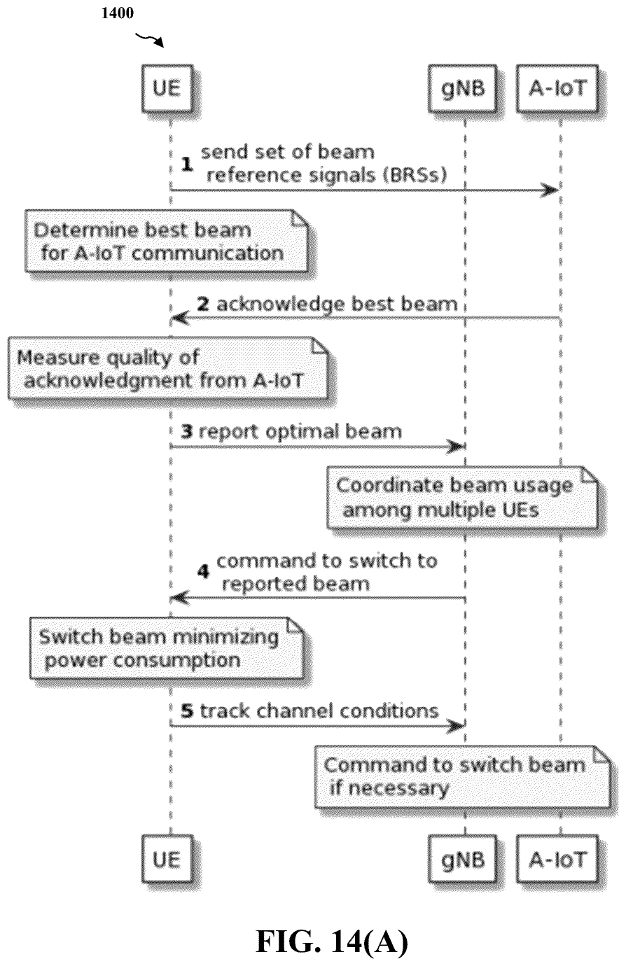

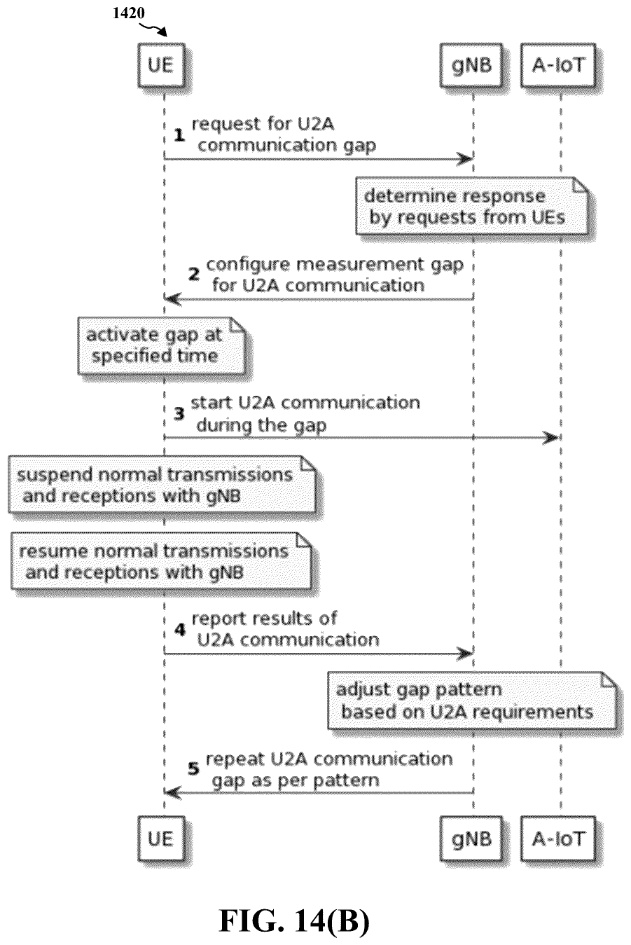

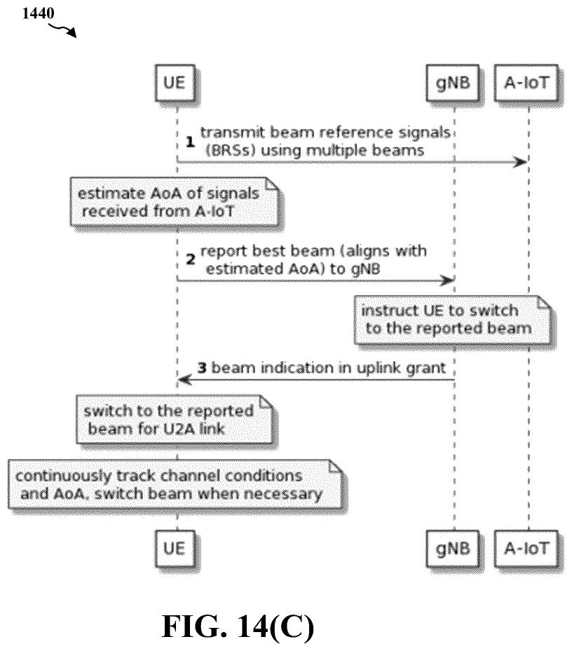

FIG. 14(A) is a sequence diagram 1400 that outlines the interactions between the UE 1104 and gNB in the context of 5G NR uplink beam management for a UE to A-IoT (R2D) link. FIG. 14(A) provides a high-level overview of the interactions between the UE 1104, gNB, and the A-IoT device 1106 in the context of 5G NR uplink beam management for a R2D link. It covers the primary steps from the UE 1104 sending a set of beam reference signals (BRSs) to the A-IoT device 1106, through to the ongoing tracking of channel conditions and potential beam switching.

In a first aspect, the UE 1104 may include:

One or more non-transitory computer-readable media having computer-executable instructions embodied thereon, and at least one processor coupled to the one or more non-transitory computer-readable media and configured to execute the computer-executable instructions to:

Receive from a base station (BS), a set of beam reference signals (BRSs), if the UE 1104 is in a communication process with the A-IoT device 1106 and the UE 1104 is determining the best beam for transmitting to the A-IoT device 1106.

Determine the optimal beam for communication with the A-IoT device 1106, if the A-IoT device 1106 has acknowledged the best beam based on the received BRSs and the UE 1104 has measured the quality of the acknowledgment from the A-IoT device 1106.

Perform the switch to the reported beam for uplink transmission to the A-IoT device 1106, if the BS has commanded the UE 1104 to switch to the reported beam and the switch is done in a way that minimizes the UE's power consumption and avoids causing interference to other UEs or A-IoT devices.

Transmit, to the BS, the optimal beam for communication with the A-IoT device 1106, if the UE 1104 has determined the optimal beam and the report includes information about the direction and width of the beam to prevent interference with other UEs or A-IoT devices.

In a second aspect, the UE 1104 may include:

One or more non-transitory computer-readable media having computer-executable instructions embodied thereon, and at least one processor coupled to the one or more non-transitory computer-readable media and configured to execute the computer-executable instructions to:

Receive from a base station (BS), a command to switch to the reported beam for uplink transmission to the A-IoT device, if the UE 1104 is in a communication process with the A-IoT device 1106 and the UE 1104 has reported the optimal beam to the BS.

Determine the timing for the beam switch, if the switch needs to be done in a way that minimizes the UE's power consumption and avoids causing interference to other UEs or A-IoT devices.

Perform tracking of the channel conditions and switch to a different beam, when necessary, if the UE 1104 and the BS need to constantly monitor the channel conditions for efficient use of the UE's power and minimizing interference.

Transmit, to the BS, the quality of the acknowledgment from the A-IoT device 1106, if the UE 1104 has measured the quality of the acknowledgment from the A-IoT device 1106 to determine the optimal beam.

### Measurement Gap

In such a scenario where the UE 1104 needs to communicate with the A-IoT device 1106 and may not be able to receive signals from the gNB during this period, a special type of measurement gap can be configured. This measurement gap can be specifically intended for UE to A-IoT (R2D) communication. Here's how it could work:

Configuration: The gNB configures a measurement gap for the UE 1104 through Radio Resource Control (RRC) signaling. This measurement gap is specifically intended for R2D communication. The gNB specifies the gap pattern, which includes the gap length and the gap period. However, since the gNB may not know how much time the UE 1104 will need to communicate with the A-IoT, it could provision a longer gap length or a flexible gap pattern that can be adjusted dynamically.

Activation: Once the R2D communication gap is configured, the UE 1104 activates the gap at the specified time. During the gap, the UE 1104 suspends its normal transmissions and receptions with the gNB and switches to the R2D communication mode.

R2D Communication: During the R2D communication gap, the UE 1104 communicates with the A-IoT device 1106. This could involve sending commands to the A-IoT device 1106, receiving responses, energizing the A-IoT device 1106, or performing other tasks related to the R2D communication.

Resumption: After the R2D communication gap, the UE 1104 resumes its normal transmissions and receptions with the gNB. The UE 1104 could report the results of the R2D communication to the gNB, which could use this information to adjust the R2D communication gap pattern or perform other network management tasks.

Repetition: The R2D communication gap is repeated according to the configured gap pattern. The gNB can adjust the gap pattern as needed based on the requirements of the R2D communication.

This approach allows the UE 1104 to communicate with the A-IoT device 1106 without significantly impacting its communication with the gNB. It also provides flexibility for the UE 1104 and the gNB to manage the R2D communication efficiently, even when the communication time is uncertain.

FIG. 14(B) is a sequence diagram 1420 that outlines the interactions between the UE 1104 and the gNB in the context of UE to A-IoT (R2D) communication with a special type of measurement gap. FIG. 14(B) provides a high-level overview of the interactions between the UE 1104, the gNB, and the A-IoT device 1106 in the context of R2D communication with a special type of measurement gap. It covers the primary steps from the UE 1104 requesting a R2D communication gap, through to the ongoing repetition of the R2D communication gap as per the configured pattern.

In a first aspect, the UE 1104 may include:

One or more non-transitory computer-readable media having computer-executable instructions embodied thereon, and at least one processor coupled to the one or more non-transitory computer-readable media and configured to execute the computer-executable instructions to:

Receive from a base station (BS), a measurement gap configuration through Radio Resource Control (RRC) signaling, if the UE 1104 needs to communicate with the A-IoT device 1106 and may not be able to receive signals from the BS during this period.

Determine the activation time of the measurement gap, if the measurement gap is configured for UE to A-IoT (R2D) communication and the BS specifies the gap pattern, which includes the gap length and the gap period.

Perform R2D communication during the measurement gap, if the UE 1104 activates the gap at the specified time and suspends its normal transmissions and receptions with the BS.

Transmit, to the BS, the results of the R2D communication, if the UE 1104 resumes its normal transmissions and receptions with the BS after the R2D communication gap and the BS could use this information to adjust the R2D communication gap pattern or perform other network management tasks.

In a second aspect, the UE 1104 may include:

One or more non-transitory computer-readable media having computer-executable instructions embodied thereon, and at least one processor coupled to the one or more non-transitory computer-readable media and configured to execute the computer-executable instructions to:

Receive from a base station (BS), a command to adjust the measurement gap pattern, if the UE 1104 has reported the results of the R2D communication to the BS and the BS needs to manage the R2D communication efficiently, even when the communication time is uncertain.

Determine the new gap pattern for the measurement gap, if the BS can adjust the gap pattern as needed based on the requirements of the R2D communication and the UE 1104 needs to follow the new gap pattern for further R2D communication.

Perform R2D communication according to the new gap pattern, if the UE 1104 has determined the new gap pattern and the R2D communication gap is repeated according to the configured gap pattern.

Transmit, to the BS, the results of the R2D communication based on the new gap pattern, if the UE 1104 performs R2D communication according to the new gap pattern and the BS could use this information to further adjust the R2D communication gap pattern or perform other network management tasks.

### DL Beam Measurement

If the UE 1104 needs to estimate the Angle of Arrival (AoA) to determine the location of the A-IoT, the beam management should indeed be based on the uplink (UL) beam direction for the UE to A-IoT (R2D) link. Here's how it could work:

Beam Determination: The UE 1104 forms multiple beams and transmits beam reference signals (BRSs) towards the A-IoT device 1106 using different beams. The A-IoT device 1106 receives these signals and responds back to the UE 1104.

AoA Estimation: The UE 1104 estimates the AoA of the signals received from the A-IoT device 1106. The AoA estimation can be done using techniques such as MUSIC (Multiple Signal Classification) or ESPRIT (Estimation of Signal Parameters via Rotational Invariance Techniques). The beam that aligns with the estimated AoA is selected as the best beam for the R2D link.

Beam Reporting: The UE 1104 reports the best beam (i.e., the beam that aligns with the estimated AoA) to the gNB. This report can be included in the regular Channel State Information (CSI) report.

Beam Switching: Based on the CSI report, the gNB instructs the UE 1104 to switch to the reported beam for the R2D link. This is typically done using a beam indication in the uplink grant.

Beam Tracking: The UE 1104 and the gNB continuously track the channel conditions and the AoA, and switch to a different beam when necessary. This is particularly important in a mobile environment where the relative position of the UE 1104 and the A-IoT device 1106 can change rapidly.

By using the UL beam direction for the R2D link, the UE 1104 can accurately estimate the AoA and therefore the location of the A-IoT device 1106. This can facilitate efficient beam management and communication between the UE 1104 and the A-IoT device 1106.

FIG. 14(C) is a sequence diagram 1440 that outlines the interactions between the UE 1104 and the gNB in the context of DL beam measurement for UE to A-IoT (R2D) communication. FIG. 14(C) provides a high-level overview of the interactions between the UE 1104, the gNB, and the A-IoT device 1106 in the context of DL beam measurement for R2D communication. It covers the primary steps from the UE 1104 transmitting beam reference signals (BRSs) to the A-IoT device 1106, through to the ongoing tracking of channel conditions and AoA, and switching to a different beam when necessary.

In a first aspect, the UE 1104 may include:

One or more non-transitory computer-readable media having computer-executable instructions embodied thereon, and at least one processor coupled to the one or more non-transitory computer-readable media and configured to execute the computer-executable instructions to:

Receive from a base station (BS), beam reference signals (BRSs) using multiple beams, if the UE 1104 needs to estimate the Angle of Arrival (AoA) to determine the location of the A-IoT device 1106.

Determine the AoA of the signals received from the A-IoT device 1106 using techniques such as MUSIC (Multiple Signal Classification) or ESPRIT (Estimation of Signal Parameters via Rotational Invariance Techniques), if the beam that aligns with the estimated AoA is selected as the best beam for the R2D link.

Perform beam switching based on the CSI report, if the gNB instructs the UE 1104 to switch to the reported beam for the R2D link. This is typically done using a beam indication in the uplink grant.

Transmit, to the BS, the best beam (i.e., the beam that aligns with the estimated AoA), if the UE 1104 and the gNB continuously track the channel conditions and the AoA, and switch to a different beam when necessary.

In a second aspect, the UE 1104 may include:

One or more non-transitory computer-readable media having computer-executable instructions embodied thereon, and at least one processor coupled to the one or more non-transitory computer-readable media and configured to execute the computer-executable instructions to:

Receive from a base station (BS), a command to adjust the beam pattern, if the UE 1104 has reported the results of the R2D communication to the BS and the BS needs to manage the R2D communication efficiently, even when the communication time is uncertain.

Determine the new beam pattern for the R2D link, if the BS can adjust the beam pattern as needed based on the requirements of the R2D communication and the UE 1104 needs to follow the new beam pattern for further R2D communication.

Perform R2D communication according to the new beam pattern, if the UE 1104 has determined the new beam pattern and the R2D communication is repeated according to the configured beam pattern.

Transmit, to the BS, the results of the R2D communication based on the new beam pattern, if the UE 1104 performs R2D communication according to the new beam pattern and the BS could use this information to further adjust the R2D communication beam pattern or perform other network management tasks.

### gNB Request and UE Report

In a scenario where the gNB needs to query an A-IoT device's Electronic Product Code (EPC) results, the gNB can request the UE 1104 to perform the query. Here's a possible sequence of events:

gNB Request: The gNB sends a request to the UE 1104 to query the EPC of a specific A-IoT device such as the A-IoT device 1106. This request can be sent through a downlink control message.

UE Query: Upon receiving the request from the gNB, the UE 1104 sends a query command to the A-IoT device 1106. This command includes the specific parameters for the A-IoT device 1106 to respond with its EPC.

A-IoT Response: The A-IoT device 1106 receives the query command from the UE 1104, decodes it, and responds with its EPC.

UE Reception and Reporting: The UE 1104 receives the EPC from the A-IoT device 1106, decodes it, and sends a report back to the gNB. This report can be sent through an uplink control message and includes the EPC of the A-IoT device 1106.

gNB Reception: The gNB receives the report from the UE 1104, decodes it, and extracts the EPC of the A-IoT device 1106.

To reuse the current 5G NR signaling and channels for communication between the gNB, the UE 1104, and the A-IoT device 1106, the following steps may be considered:

Downlink Control Information (DCI): the gNB can use DCI to instruct the UE 1104 to perform certain tasks related to A-IoT communication. For example, the gNB can use DCI to send a request to the UE 1104 to query the EPC of a specific A-IoT device such as the A-IoT device 1106. The DCI can be sent on the Physical Downlink Control Channel (PDCCH).

Uplink Control Information (UCI): After the UE 1104 performs the task (like querying the EPC from the A-IoT device 1106), it can use UCI to report the results back to the gNB. The UCI can include the EPC of the A-IoT device 1106 or other relevant information. The UCI can be sent on the Physical Uplink Control Channel (PUCCH) or multiplexed on the Physical Uplink Shared Channel (PUSCH) if uplink data is also being sent.

Physical Channels: The Physical Uplink Shared Channel (PUSCH) and Physical Downlink Shared Channel (PDSCH) can be used for data transmission between the UE 1104 and the gNB. The UE 1104 can use these channels to relay data between the gNB and the A-IoT device 1106.

RRC Signaling: The gNB and the UE 1104 can use Radio Resource Control (RRC) signaling to establish and manage the A-IoT communication. For example, the gNB can use RRC signaling to configure the measurement gaps for the UE 1104 to communicate with the A-IoT device 1106.

By reusing the current 5G NR signaling and channels, the communication between the gNB, the UE 1104, and the A-IoT device 1106 can be integrated into the existing 5G NR framework. This can facilitate the deployment of A-IoT devices in 5G networks and enable efficient and reliable communication between these devices and the network.

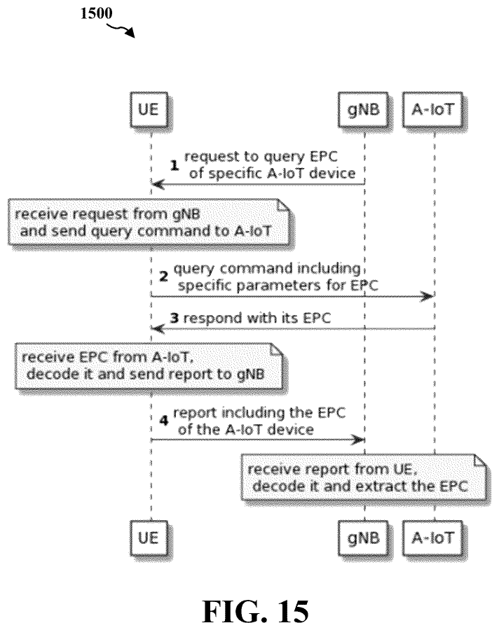

FIG. 15 is a sequence diagram 1500 that outlines the interactions between the UE 1104 and the gNB in the context of querying an A-IoT device's Electronic Product Code (EPC). FIG. 15 provides a high-level overview of the interactions between the UE 1104, the gNB, and the A-IoT device 1106 in the context of querying an A-IoT device's EPC. It covers the primary steps from the gNB sending a request to the UE 1104 to query the EPC of the A-IoT device 1106, through to the gNB receiving the report from the UE 1104 and extracting the EPC of the A-IoT device 1106.

In a first aspect, the UE 1104 may include:

One or more non-transitory computer-readable media having computer-executable instructions embodied thereon, and at least one processor coupled to the one or more non-transitory computer-readable media and configured to execute the computer-executable instructions to:

Receive from a base station (BS), a request to query the Electronic Product Code (EPC) of a specific A-IoT device such as the A-IoT device 1106 through a downlink control message, if the UE 1104 is in a scenario where the gNB needs to query an A-IoT device's EPC results.

Determine the specific parameters for the A-IoT device 1106 to respond with its EPC, if the UE 1104 receives the request from the gNB and needs to send a query command to the A-IoT device 1106.

Perform the task of querying the EPC from the A-IoT device 1106, if the UE 1104 receives the request from the gNB and uses Downlink Control Information (DCI) to perform certain tasks related to A-IoT communication.

Transmit, to the BS, a report including the EPC of the A-IoT device 1106 through an uplink control message, if the UE 1104 receives the EPC from the A-IoT device 1106, decodes it, and needs to report back to the gNB.

In a second aspect, the UE 1104 may include:

One or more non-transitory computer-readable media having computer-executable instructions embodied thereon, and at least one processor coupled to the one or more non-transitory computer-readable media and configured to execute the computer-executable instructions to:

Receive from a base station (BS), a command to perform certain tasks related to A-IoT communication using Downlink Control Information (DCI), if the UE 1104 is in a scenario where the gNB needs to query an A-IoT device's EPC results.

Determine the specific parameters for the A-IoT device 1106 to respond with its EPC, if the UE 1104 receives the command from the gNB and needs to send a query command to the A-IoT device 1106.

Perform the task of querying the EPC from the A-IoT device 1106, if the UE 1104 receives the command from the gNB and uses Uplink Control Information (UCI) to perform certain tasks related to A-IoT communication.

Transmit, to the BS, a report including the EPC of the A-IoT device 1106 through an uplink control message, if the UE 1104 receives the EPC from the A-IoT device 1106, decodes it, and needs to report back to the gNB.

### gNB Controls R2D Link

The gNB can configure the A-IoT device 1106 via the Uu interface by using the R2D link through a series of steps involving the UE 1104. The Uu interface is the air interface between the gNB and the UE 1104, while the R2D link is a communication link between the UE 1104 and the A-IoT device 1106. Here's a possible sequence of events:

gNB to UE Command Transmission: The gNB sends a command to the UE 1104 intended for the A-IoT device 1106. This command can be transmitted via the Uu interface using standard 5G NR signaling and channels, such as the Physical Downlink Control Channel (PDCCH) or the Physical Downlink Shared Channel (PDSCH). The command includes configuration parameters for the A-IoT device 1106.

UE to A-IoT Device Command Relaying: The UE 1104, upon receiving the command from the gNB, relays this command to the A-IoT device 1106 via the R2D link. The R2D link can employ various modulation schemes such as Amplitude Shift Keying (ASK) or Frequency Shift Keying (FSK) to transmit the command to the A-IoT device 1106.

IoT Device Configuration: The A-IoT device 1106 receives the command from the UE 1104, decodes it, and applies the configuration parameters. The configuration parameters can include settings related to the A-IoT device's operation, such as power management, data reporting intervals, and sensor calibration parameters.

IoT Device to UE Confirmation Transmission: Once the A-IoT device 1106 has successfully applied the configuration parameters, it sends a confirmation message back to the UE 1104 via the R2D link. This confirmation message indicates that the configuration has been successfully applied.

UE to gNB Confirmation Relaying: The UE 1104, upon receiving the confirmation message from the A-IoT device 1106, relays this confirmation back to the gNB via the Uu interface. This could be transmitted through an uplink control message on channels like the Physical Uplink Control Channel (PUCCH) or the Physical Uplink Shared Channel (PUSCH).

gNB Confirmation Reception: The gNB receives the confirmation message from the UE 1104, decodes it, and confirms that the A-IoT device 1106 has been successfully configured.

This process allows the gNB to configure the A-IoT device 1106 indirectly via the Uu interface and the R2D link, using the UE 1104 as a relay. This is particularly useful in scenarios where the A-IoT device 1106 is a passive device with limited communication capabilities, and the UE 1104 serves as a communication bridge between the gNB and the A-IoT device 1106.

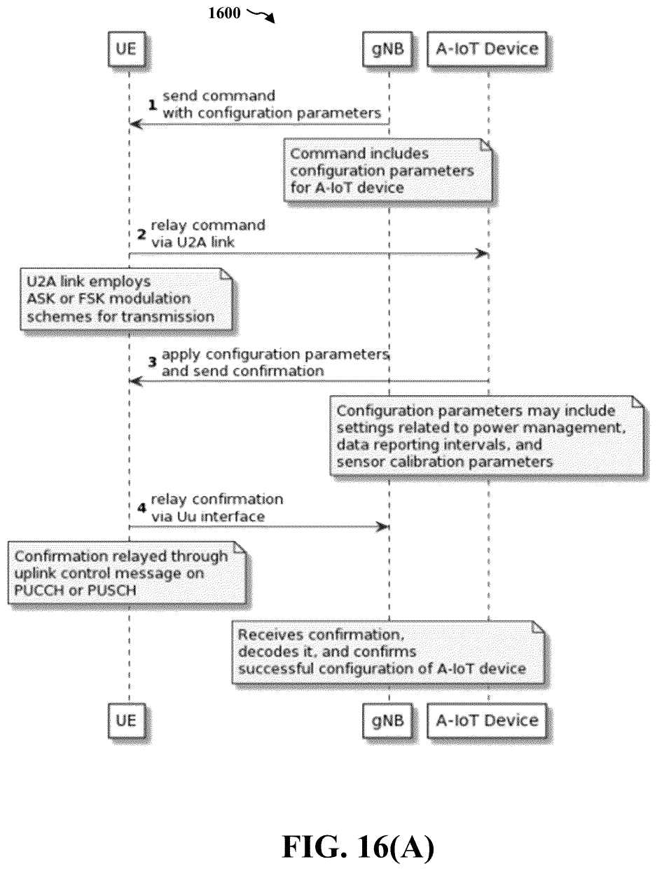

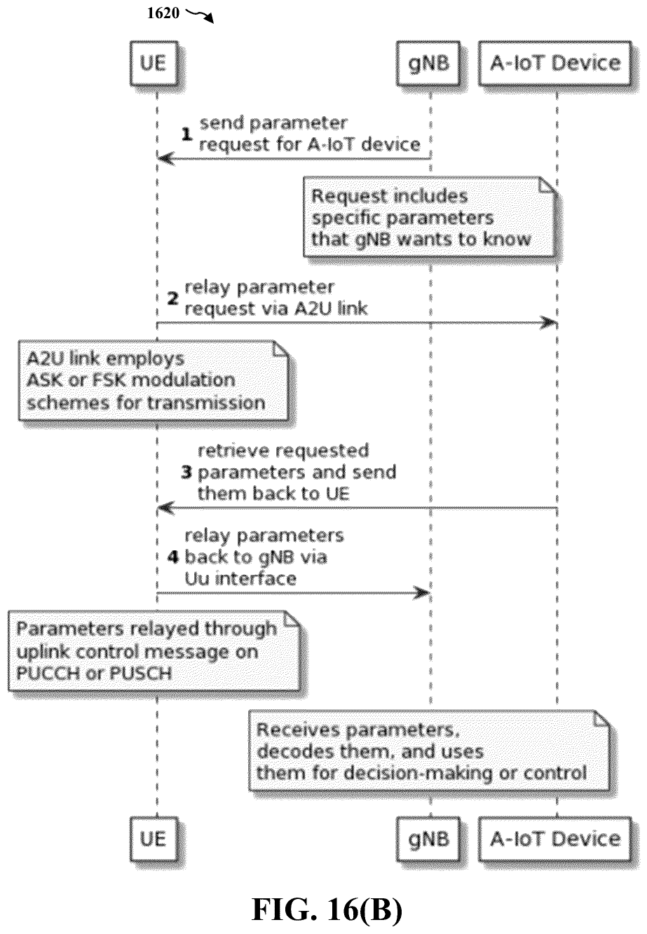

FIG. 16(A) is a sequence diagram 1600 illustrates the interaction between the gNB, the UE 1104, and the A-IoT device 1106 during the configuration process in which the gNB controls R2D link. It shows how commands and confirmations are relayed through the Uu interface and the R2D link, and how the A-IoT device 1106 applies the configuration parameters.

In a first aspect, the UE 1104 may include:

one or more non-transitory computer-readable media having computer-executable instructions embodied thereon, and at least one processor coupled to the one or more non-transitory computer-readable media and configured to execute the computer-executable instructions to:

Receive from a base station (BS), a command intended for the A-IoT device 1106 via the Uu interface, if the UE 1104 is serving as a communication bridge between the BS and the A-IoT device 1106.

Determine the configuration parameters for the A-IoT device 1106 included in the command, if the command is received successfully.

Perform the relay of the command to the A-IoT device 1106 via the R2D link, if the configuration parameters are determined successfully.

Transmit, to the BS, a confirmation message back via the Uu interface, if the A-IoT device 1106 successfully applies the configuration parameters and sends a confirmation message to the UE 1104.

In a second aspect, the UE 1104 may include:

one or more non-transitory computer-readable media having computer-executable instructions embodied thereon, and at least one processor coupled to the one or more non-transitory computer-readable media and configured to execute the computer-executable instructions to:

Receive from a gNB, a command via the Uu interface using standard 5G NR signaling and channels, if the UE 1104 is in a scenario where the A-IoT device 1106 is a passive device with limited communication capabilities.

Determine the modulation schemes such as Amplitude Shift Keying (ASK) or Frequency Shift Keying (FSK) for transmitting the command to the A-IoT device 1106 via the R2D link, if the command is intended for the A-IoT device 1106.

Perform the relay of the command to the A-IoT device 1106 via the R2D link using the determined modulation schemes, if the command is received successfully from the gNB.

Transmit, to the gNB, a confirmation message back via the Uu interface through an uplink control message on channels like the Physical Uplink Control Channel (PUCCH) or the Physical Uplink Shared Channel (PUSCH), if the A-IoT device 1106 successfully applies the configuration parameters and sends a confirmation message to the UE 1104.

### gNB Controls D2R Link

FIG. 16(B) is a sequence diagram 1620 illustrates the interaction between the gNB, the UE 1104, and the A-IoT device 1106 during the configuration process in which the gNB controls D2R link.

The gNB can control the D2R link (the link between the UE 1104 and the A-IoT device 1106) indirectly through the Uu interface (the link between the gNB and the UE 1104) by sending commands or requests to the UE 1104, which then relays these commands or requests to the A-IoT device 1106 via the D2R link. Here's a possible sequence of events:

gNB to UE Parameter Request Transmission: The gNB sends a parameter request to the UE 1104 intended for the A-IoT device 1106. This request can be transmitted via the Uu interface using standard 5G NR signaling and channels, such as the Physical Downlink Control Channel (PDCCH) or the Physical Downlink Shared Channel (PDSCH). The request includes specific parameters that the gNB wants to know from the A-IoT device 1106.

UE to A-IoT device Parameter Request Relaying: The UE 1104, upon receiving the parameter request from the gNB, relays this request to the A-IoT device 1106 via the D2R link. The D2R link can employ various modulation schemes such as Amplitude Shift Keying (ASK) or Frequency Shift Keying (FSK) to transmit the request to the A-IoT device 1106.

A-IoT Device Parameter Reporting: The A-IoT device 1106 receives the request from the UE 1104, retrieves the requested parameters, and sends these parameters back to the UE 1104 via the D2R link.

UE to gNB Parameter Reporting: The UE 1104, upon receiving the parameters from the A-IoT device 1106, relays these parameters back to the gNB via the Uu interface. This could be transmitted through an uplink control message on channels like the Physical Uplink Control Channel (PUCCH) or the Physical Uplink Shared Channel (PUSCH).

gNB Parameter Reception: The gNB receives the parameters from the UE 1104, decodes them, and uses them for further decision-making or control.

This process allows the gNB to request and receive specific parameters from the A-IoT device 1106 indirectly via the Uu interface and the D2R link, using the UE 1104 as a relay. This is particularly useful in scenarios where the A-IoT device 1106 is a passive device with limited communication capabilities, and the UE 1104 serves as a communication bridge between the gNB and the A-IoT device 1106.

As shown in FIG. 16(B), the gNB sends a parameter request to the UE 1104, which then relays the request to the A-IoT device 1106 via the D2R link. The A-IoT device 1106 retrieves the requested parameters and sends them back to the UE 1104, which then relays the parameters back to the gNB via the Uu interface. The gNB then uses these parameters for further decision-making or control.

In a first aspect, the UE 1104 may include:

one or more non-transitory computer-readable media having computer-executable instructions embodied thereon, and at least one processor coupled to the one or more non-transitory computer-readable media and configured to execute the computer-executable instructions to:

Receive from a gNB, a parameter request for the A-IoT device 1106 via the Uu interface if the UE 1104 serves as a communication bridge between the gNB and the A-IoT device 1106.

Determine the specific parameters included in the request if the parameter request is received successfully.

Perform the relay of the parameter request to the A-IoT device 1106 via the D2R link using ASK or FSK modulation schemes if the specific parameters are determined.

Transmit, to the gNB, the retrieved parameters from the A-IoT device 1106 via the Uu interface using PUCCH or PUSCH if the A-IoT device 1106 sends the parameters back to the UE 1104.

In a second aspect, the UE 1104 may include:

one or more non-transitory computer-readable media having computer-executable instructions embodied thereon, and at least one processor coupled to the one or more non-transitory computer-readable media and configured to execute the computer-executable instructions to:

Receive from a gNB, a command intended for the A-IoT device 1106 via the Uu interface using PDCCH or PDSCH channels if the A-IoT device 1106 has limited communication capabilities.

Determine the command parameters for the A-IoT device 1106 if the command is received successfully.

Perform the relay of the command to the A-IoT device 1106 via the D2R link employing ASK or FSK modulation schemes if the command parameters are determined.

Transmit, to the gNB, a confirmation message back via the Uu interface through an uplink control message on PUCCH or PUSCH if the A-IoT device 1106 applies the command parameters and sends a confirmation message to the UE 1104.

In a second aspect, the UE 1104 may include:

One or more non-transitory computer-readable media having computer-executable instructions embodied thereon, and at least one processor coupled to the one or more non-transitory computer-readable media and configured to execute the computer-executable instructions to:

Receive from a base station (BS), beam reference signals (BRSs) using multiple beams, if the UE 1104 needs to estimate the Angle of Arrival (AoA) to determine the location of the A-IoT device 1106.

Determine the AoA of the signals received from the A-IoT device 1106 using techniques such as MUSIC (Multiple Signal Classification) or ESPRIT (Estimation of Signal Parameters via Rotational Invariance Techniques), if the beam that aligns with the estimated AoA is selected as the best beam for the R2D link.

Perform beam switching based on the CSI report, if the gNB instructs the UE 1104 to switch to the reported beam for the R2D link. This is typically done using a beam indication in the uplink grant.

Transmit, to the BS, the best beam (i.e., the beam that aligns with the estimated AoA), if the UE 1104 and the gNB continuously track the channel conditions and the AoA, and switch to a different beam when necessary.

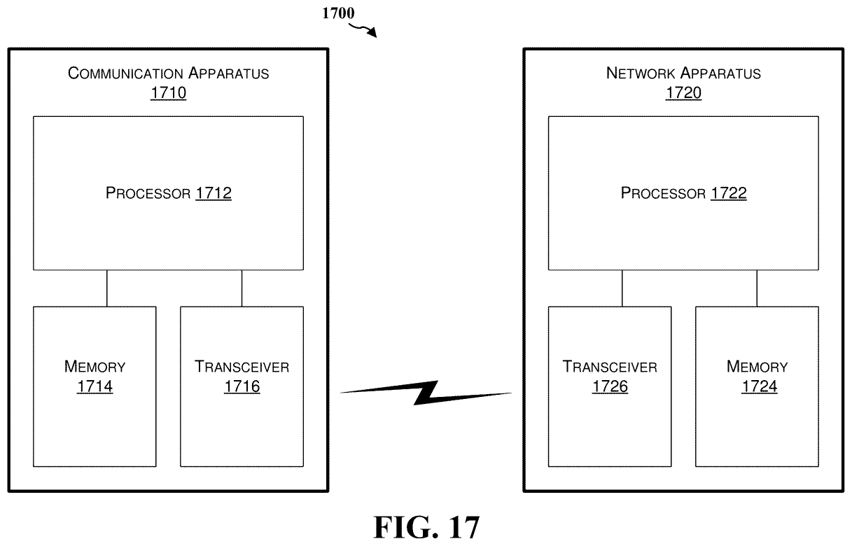

FIG. 17 illustrates an example communication system 1700 having an example communication apparatus 1710 and an example network apparatus 1720 in accordance with an implementation of the present disclosure. Each of communication apparatus 1710 and network apparatus 1720 may perform various functions to implement schemes, techniques, processes and methods described herein pertaining to using on-demand reference signal for network energy saving with respect to user equipment and network apparatus in mobile communications, including scenarios/schemes described above.

Communication apparatus 1710 may be a part of an electronic apparatus, which may be a UE such as a portable or mobile apparatus, a wearable apparatus, a wireless communication apparatus or a computing apparatus. For instance, communication apparatus 1710 may be implemented in a smartphone, a smartwatch, a personal digital assistant, a digital camera, or a computing equipment such as a tablet computer, a laptop computer or a notebook computer. Communication apparatus 1710 may also be a part of a machine type apparatus, which may be an IoT, NB-IoT, or IIoT apparatus such as an immobile or a stationary apparatus, a home apparatus, a wire communication apparatus or a computing apparatus. For instance, communication apparatus 1710 may be implemented in a smart thermostat, a smart fridge, a smart door lock, a wireless speaker or a home control center. Alternatively, communication apparatus 1710 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 1710 may include at least some of those components shown in FIG. 17 such as a processor 1712, for example. Communication apparatus 1710 may further include one or more other components not pertinent to the proposed scheme of the present disclosure (e.g., internal power supply, display device and/or user interface device), and, thus, such component(s) of communication apparatus 1710 are neither shown in FIG. 17 nor described below in the interest of simplicity and brevity.

Network apparatus 1720 may be a part of a network apparatus, which may be a network node such as a satellite, a base station, a small cell, a router or a gateway. For instance, network apparatus 1720 may be implemented in an eNodeB in an LTE network, in a gNB in a 5G/NR, IoT, NB-IoT or IIoT network or in a satellite or base station in a 6G network. Alternatively, network apparatus 1720 may be implemented in the form of one or more IC chips such as, for example and without limitation, one or more single-core processors, one or more multi-core processors, or one or more RISC or CISC processors. Network apparatus 1720 may include at least some of those components shown in FIG. 17 such as a processor 1722, for example. Network apparatus 1720 may further include one or more other components not pertinent to the proposed scheme of the present disclosure (e.g., internal power supply, display device and/or user interface device), and, thus, such component(s) of network apparatus 1720 are neither shown in FIG. 17 nor described below in the interest of simplicity and brevity.

In one aspect, each of processor 1712 and processor 1722 may be implemented in the form of one or more single-core processors, one or more multi-core processors, or one or more CISC processors. That is, even though a singular term “a processor” is used herein to refer to processor 1712 and processor 1722, each of processor 1712 and processor 1722 may include multiple processors in some implementations and a single processor in other implementations in accordance with the present disclosure. In another aspect, each of processor 1712 and processor 1722 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 1712 and processor 1722 is a special-purpose machine specifically designed, arranged and configured to perform specific tasks including autonomous reliability enhancements in a device (e.g., as represented by communication apparatus 1710) and a network (e.g., as represented by network apparatus 1720) in accordance with various implementations of the present disclosure.

In some implementations, communication apparatus 1710 may also include a transceiver 1716 coupled to processor 1712 and capable of wirelessly transmitting and receiving data. In some implementations, communication apparatus 1710 may further include a memory 1714 coupled to processor 1712 and capable of being accessed by processor 1712 and storing data therein. In some implementations, network apparatus 1720 may also include a transceiver 1726 coupled to processor 1722 and capable of wirelessly transmitting and receiving data. In some implementations, network apparatus 1720 may further include a memory 1724 coupled to processor 1722 and capable of being accessed by processor 1722 and storing data therein. Accordingly, communication apparatus 1710 and network apparatus 1720 may wirelessly communicate with each other via transceiver 1716 and transceiver 1726, respectively. To aid better understanding, the following description of the operations, functionalities and capabilities of each of communication apparatus 1710 and network apparatus 1720 is provided in the context of a mobile communication environment in which communication apparatus 1710 is implemented in or as a communication apparatus or a UE and network apparatus 1720 is implemented in or as a network node of a communication network.

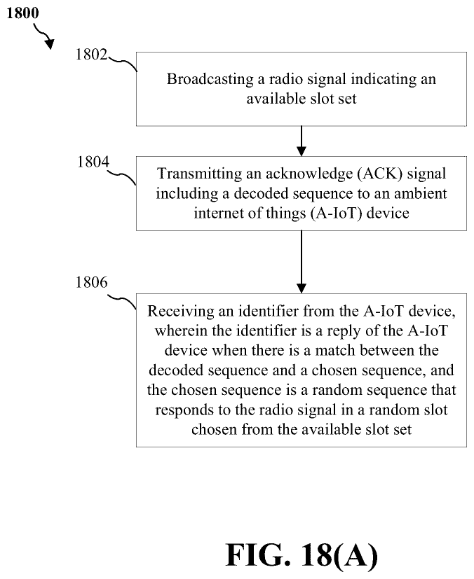

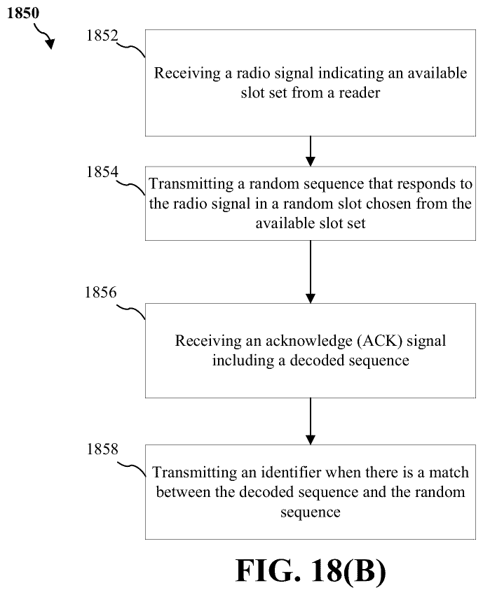

FIG. 18(A) is a flow chart 1800 of a process for identifying regarding a reader and an A-IoT device. This process involves interactions between a gNB, a UE (e.g., the UE 1104), and an ambient internet of things (A-IoT) device (e.g., the A-IoT device 1106).

At block 1802, a reader may broadcast a radio signal indicating an available slot set. The reader may be the UE 1104 or the gNB.

Then, at block 1804, the reader, e.g., the UE 1104, may transmit an acknowledge (ACK) signal including a decoded sequence to the ambient internet of things (A-IoT) device 1106.

Finally, at block 1806, the reader may receive an identifier from the A-IoT device. In some embodiments, the identifier may be a reply of the A-IoT device 1106 when there is a match between the decoded sequence and a chosen sequence, and the chosen sequence is a random sequence that responds to the radio signal in a random slot chosen from the available slot set.

In some embodiments, when the reader is the UE 1104, the method may further include: forwarding the identifier to a base station, e.g., the gNB. Furthermore, in some embodiments, the method may further include: forwarding the random sequence to the base station; and receiving the ACK signal from the base station. In some embodiments, the decoded sequence may be obtained by the base station decoding the random sequence. In some embodiments, the UE 1104 may also receive from the base station a control signal specifying control parameters when the UE 1104 is in a communication process with the A-IoT device 1106. In some embodiments, the control parameters may include the available slot set.

In some embodiments, validity of signals between the reader and the A-IoT device may be checked by using a cyclic-redundancy check (CRC).

In some embodiments, the radio signal may include a protocol-control information (PCI) that regulates timing and format of data transmission between the reader such as the UE 1104 and the A-IoT device 1106.

In some embodiments, the random sequence may be a modulated sequence using FM0 modulation, and be preceded by a preamble sequence.

In some embodiments, a reader-to-device (R2D) link from the reader such as the UE 1104 to the A-IoT device 1106 may employ a modulation scheme including amplitude shift keying (ASK) or on-off keying (OOK). The ASK, for example, may include double sideband amplitude shift keying (DSB-ASK), single sideband amplitude shift keying (SSB-ASK), and partial response amplitude shift keying (PR-ASK).

In some embodiments, a first R2D preamble may be used for an initial transmission between the UE 1104 and the A-IoT device 1106 to enable the A-IoT device 1106 to synchronize with the UE 1104, a second R2D preamble may be used for a start of a signaling after the synchronization between the UE 1104 and the A-IoT device 1106. The second R2D preamble may be shorter than the first R2D preamble.

In some embodiments, the reader such as the UE 1104 may employ Manchester encoding and pulse-interval encoding (PIE) for a reader-to-device (R2D) communication from the UE 1104 to the A-IoT device 1106.

FIG. 18(B) is a flow chart 1850 of another process for identifying regarding a reader and an A-IoT device.

At block 1852, an A-IoT device, e.g., the A-IoT device 1106, may receive a radio signal indicating an available slot set from a reader. The reader, may be a UE, e.g., the UE 1104, or a gNB.

Then, at block 1854, the A-IoT device 1106 may transmit a random sequence that responds to the radio signal in a random slot chosen from the available slot set.

Subsequently, at block 1856, the A-IoT device 1106 may receive an acknowledge (ACK) signal including a decoded sequence.

Finally, at block 1856, the A-IoT device 1106 may transmit an identifier when there is a match between the decoded sequence and the random sequence.

In some embodiments, validity of signals between the reader such as the UE 1104 and the A-IoT device 1106 may be checked by using a cyclic-redundancy check (CRC).

In some embodiments, the radio signal may include a protocol-control information (PCI) that regulates timing and format of data transmission between the reader and the A-IoT device.

In some embodiments, the random sequence may be a modulated sequence using FM0 modulation, and be preceded by a preamble sequence.

In some embodiments, a device-to-reader (D2R) link from the A-IoT device 1106 to the reader such as the UE 1104 may employ a modulation scheme including amplitude shift keying (ASK) or phase shift keying (PSK).

In some embodiments, the A-IoT device 1106 may reply to a command from the reader by using an immediate reply, a delayed reply or an in-process reply.

In some embodiments, the A-IoT device 1106 may use an extended preamble for the delayed reply or the in-process reply.

In some embodiments, the A-IoT device 1106 may employ a backscatter modulation to alter an antenna's reflection coefficient to transmit data.

In some embodiments, the A-IoT device 1106 may select a modulation format, data encoding, and data rate according to a setting from the reader.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of wireless communication of a reader, comprising:
broadcasting a radio signal indicating an available slot set;
transmitting an acknowledge (ACK) signal including a decoded sequence to an ambient internet of things (A-IoT) device; and
receiving an identifier from the A-IoT device, wherein the identifier is a reply of the A-IoT device when there is a match between the decoded sequence and a chosen sequence, and the chosen sequence is a random sequence that responds to the radio signal in a random slot chosen from the available slot set.

2. The method of claim 1, wherein the reader comprises a user equipment (UE) or a gNodeB (gNB).

3. The method of claim 2, wherein when the reader is the UE, the method further comprises:
forwarding the identifier to a base station.

4. The method of claim 3, further comprising:
forwarding the random sequence to the base station; and
receiving the ACK signal from the base station, wherein the decoded sequence is obtained by the base station decoding the random sequence.

5. The method of claim 3, wherein the UE receives from the base station a control signal specifying control parameters when the UE is in a communication process with the A-IoT device.

6. The method of claim 5, wherein the control parameters comprise the available slot set.

7. The method of claim 1, wherein validity of signals between the reader and the A-IoT device is checked by using a cyclic-redundancy check (CRC).

8. The method of claim 1, wherein the radio signal comprises a protocol-control information (PCI) that regulates timing and format of data transmission between the reader and the A-IoT device.

9. The method of claim 1, wherein the random sequence is a modulated sequence using FM0 modulation, and is preceded by a preamble sequence.

10. The method of claim 2, wherein a reader-to-device (R2D) link from the reader to the A-IoT device employs a modulation scheme including amplitude shift keying (ASK) or on-off keying (OOK), wherein the ASK comprises double sideband amplitude shift keying (DSB-ASK), single sideband amplitude shift keying (SSB-ASK), and partial response amplitude shift keying (PR-ASK).

11. The method of claim 10, wherein a first R2D preamble is used for an initial transmission between the UE and the A-IoT device to enable the A-IoT device to synchronize with the UE, a second R2D preamble is used for a start of a signaling after the synchronization between the UE and the A-IoT device, and the second R2D preamble is shorter than the first R2D preamble.

12. The method of claim 1, wherein the reader employs Manchester encoding and pulse-interval encoding (PIE) for a reader-to-device (R2D) communication from the reader to the A-IoT device.

13. A method of wireless communication of an ambient internet of things (A-IoT) device, comprising:
receiving a radio signal indicating an available slot set from a reader;
transmitting a random sequence that responds to the radio signal in a random slot chosen from the available slot set;
receiving an acknowledge (ACK) signal including a decoded sequence; and
transmitting an identifier when there is a match between the decoded sequence and the random sequence.

14. The method of claim 13, wherein validity of signals between the reader and the A-IoT device is checked by using a cyclic-redundancy check (CRC).

15. The method of claim 13, wherein the radio signal comprises a protocol-control information (PCI) that regulates timing and format of data transmission between the reader and the A-IoT device.

16. The method of claim 13, wherein the random sequence is a modulated sequence using FM0 modulation, and is preceded by a preamble sequence.

17. The method of claim 13, wherein a device-to-reader (D2R) link from the A-IoT device to the reader employs a modulation scheme including amplitude shift keying (ASK) or phase shift keying (PSK); and/or
the A-IoT device employs a backscatter modulation to alter an antenna's reflection coefficient to transmit data, wherein the A-IoT device selects a modulation format, data encoding, and data rate according to a setting from the reader.

18. The method of claim 13, wherein the A-IoT device replies to a command from the reader by using an immediate reply, a delayed reply or an in-process reply, wherein the A-IoT device uses an extended preamble for the delayed reply or the in-process reply.

19. An apparatus for wireless communication, the apparatus being a reader, comprising:
a memory; and
at least one processor coupled to the memory and configured to:
broadcast a radio signal indicating an available slot set;
transmit an acknowledge (ACK) signal including a decoded sequence to an ambient internet of things (A-IoT) device; and
receive an identifier from the A-IoT device, wherein the identifier is a reply of the A-IoT device when there is a match between the decoded sequence and a chosen sequence, and the chosen sequence is a random sequence that responds to the radio signal in a random slot chosen from the available slot set.

20. An apparatus for wireless communication, the apparatus being an ambient internet of things (A-IoT) device, comprising:
a memory; and
at least one processor coupled to the memory and configured to:
receiving a radio signal indicating an available slot set from a reader;
transmitting a random sequence that responds to the radio signal in a random slot chosen from the available slot set;
receiving an acknowledge (ACK) signal including a decoded sequence; and
transmitting an identifier when there is a match between the decoded sequence and the random sequence.
